(19) United States
(12) Patent Application Publication
(10) Pub. No.: US 2021/0056762 A1
(43) Pub. Date: Feb. 25, 2021

(54) DESIGN AND GENERATION OF AUGMENTED REALITY EXPERIENCES FOR STRUCTURED DISTRIBUTION OF CONTENT BASED ON LOCATION-BASED TRIGGERS

(71) Applicants: Nicolas ROBBE, Acton, MA (US); Milan KOCAVEC, Acton, MA (US); Hoverlay, Inc., Action, MA (US)

(72) Inventors: Nicolas Robbe, Acton, MA (US); Milan Kovacev, Winchester, MA (US)

(73) Assignee: Hoverlay, Inc., Action, MA (US)

(21) Appl. No.: 17/040,376

(22) PCT Filed: Mar. 22, 2019
(86) PCT No.: PCT/US2019/023744

§ 371 Date: Sep. 22, 2020

Related U.S. Application Data
(60) Provisional application No. 62/647,542, filed on Mar. 23, 2018.

(51) Int. Cl. G06T 19/00; G06F 16/29; G06F 16/22; G06T 7/70; G06F 16/2457

(52) U.S. Cl. CPC G06T 19/006; G06F 16/29; G06T 2207/10028; G06T 7/70; G06F 16/2457; G06F 16/2282

(57) ABSTRACT

Systems and methods for managing augmented reality (AR) experiences allow multiple users, who may have no prior relationship or connection with each other, to share content (documents, phone numbers, emails, messages, and/or links thereto), and actions (give a rating, fund our campaign, contact us) by placing them in the physical world. A user registers content in the physical world by “augmenting” the real world.

### CROSS REFERENCE TO RELATED APPLICATION

This application claims priority to U.S. Provisional Patent Application No. 62/647,542 entitled “DESIGN AND GENERATION OF AUGMENTED REALITY EXPERIENCES FOR STRUCTURED DISTRIBUTION OF CONTENT BASED ON LOCATION-BASED TRIGGERS,” filed Mar. 23, 2018, and incorporated herein by reference in its entirety.

### BACKGROUND

Augmented reality (AR) involves augmenting a physical environment with non-physical but nonetheless perceivable elements. Conventional AR involves a content provider providing a set of virtual objects that are presented to a user via a display screen of a user device. The content provider is normally an entity with a team of specialized technical professionals, and users do not choose what is presented or how. Typical users do not have the technical knowhow or resources to design and distribute AR experiences that can be used to share content. Moreover, AR experiences may involve adding virtual elements regardless of the location of the user or what is in the physical environment of the user.

### SUMMARY

At least one aspect is directed to a method for providing digital content in an augmented reality environment. The method may involve maintaining, by a server, one or more layers associated with a particular set of geographical coordinates, each layer corresponding to a respective content publisher. The server may receive, from a client device of the content publisher, a request to associate and/or store a scene object with a layer for access on the layer via a client device of a user, the request identifying an anchor relative to which to present the scene object, one or more presentation attributes and/or one or more access permissions. The method may also involve the server generating data identifying the scene object, the anchor, the layer, the set of geographical coordinates, the one or more presentation attributes, the one or more access permissions and/or at least one of a digital asset corresponding to the scene object and a link to a location at which the digital asset is stored. In some implementations, the data may be stored, for example, in a data structure. The server may receive, from an application executing on a client device, a request for an AR asset corresponding to a particular layer. The method may also involve transmitting, by the server to the client device, the AR asset corresponding to the layer, the AR asset including the data generated by the server relating to or more scene objects associated to the layer. The application executing on the client device may be configured to present the scene object on a display at a physical location associated with the anchor according to the one or more presentation attributes and/or according to the one or more access permissions.

In some implementations, the application is further configured to, upon selection of the scene object, provide access to the digital asset.

In some implementations, the digital asset is at least one of an image, a sound, a video, and a document.

In some implementations, the application is further configured to display real-time imagery from a camera of the client device, and wherein the anchor is a physical object in the imagery.

In some implementations, the physical object is at least one of a substantially vertical wall and a substantially horizontal flat surface.

In some implementations, the application is further configured to display a map of a geographical location of the client device, and the anchor is an object viewable in the map.

In some implementations, the object is a physical object represented by a set of photos, or other representation, of a building or other physical object at the geographical location. For example, an anchor representing a building may be one or several photos of the building, and could be a type of anchor that may also be used for, for example, a book cover or logo.

In some implementations, the anchor identifies a wall on which the scene object is to be displayed.

In some implementations, the application is further configured to vary a size of the scene object such that the size decreases as the client device approaches the scene object and the size increases as the client device moves away from the scene object.

At least one aspect is directed to a method for creating, via a client device of a client, an augmented reality experience for a user device of a user. The method may involve transmitting to a server, via an application running on the client device, a digital asset to be made accessible to the user device via the server. The method may further involve selecting, via the application, a scene object to be associated with the digital asset, a set of presentation attributes for the scene object, and one or more access permissions for the scene object. Via the application, a set of preconditions under which the scene object is to be presented to users via the server may be identified. The preconditions may include at least one of a geographical location and a time period. Also via the application, an anchor relative to which the scene object is to be presented according to the presentation attributes and access permissions on a user display of the user device may be identified. The identified set of preconditions, scene object selection, presentation attributes, and/or one or more access permissions may be transmitted to a server for association with a layer corresponding to the client. Layers within a predetermined distance of the user device and/or associated with the client may be searchable by the user via the server.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram depicting a computer networked environment for presenting and managing augmented reality (AR) experiences, according to illustrative implementations;

FIG. 1B is a block diagram depicting a computer networked environment with client devices that can be used for creating and managing AR experiences, according to illustrative implementations;

FIG. 1C is a block diagram depicting a computer networked environment with client devices that can be used to locate and consume AR experiences, according to illustrative implementations;

FIG. 1D is a block diagram depicting features of digital assets of an AR system, according to illustrative implementations;

FIG. 2A is a logical representation of associations between geographic areas, layers, anchors, and scene objects, according to illustrative implementations;

FIG. 2B is a representation of associations between geographic areas, layers, anchors, and scene objects, according to illustrative implementations;

FIG. 3 depicts an example server with four potential client types, according to illustrative implementations;

FIG. 4 depicts entity relationships for example AR systems, according to illustrative implementations;

FIG. 5 depicts example user interfaces (UIs) and elements/functions thereof, according to illustrative implementations;

FIG. 6 depicts example user flows for implementing an AR system, according to illustrative implementations;

FIG. 7 depicts an example creation flow for custom image anchors, according to illustrative implementations;

FIG. 8 provides a flow diagram for an example process for implementing an AR system, according to illustrative implementations;

FIG. 9 provides a flow diagram for an example process for implementing an AR system, according to illustrative implementations;

FIG. 10 provides a flow diagram for an example process for implementing an AR system, according to illustrative implementations;

FIG. 11 provides a flow diagram for an example process for implementing an AR system, according to illustrative implementations;

FIG. 12 illustrates an example AR experience of users of an AR system, according to illustrative implementations;

FIG. 13 illustrates an example AR experience of users of an AR system, according to illustrative implementations;

FIG. 14 depicts example scene object elements for an AR system, according to illustrative implementations;

FIG. 15 depicts an example user interface with a list of layers accessible in a geographic area, according to illustrative implementations;

FIG. 16 provides an example of a map view for an AR system, according to illustrative implementations;

FIG. 17 provides an example of a map view for an AR system, according to illustrative implementations;

FIG. 18 provides an example of a live camera view for an AR system, according to illustrative implementations;

FIG. 19 is a block diagram illustrating a general architecture for a computer system that may be employed to implement elements of the systems and methods described and illustrated herein, according to illustrative implementations.

### DETAILED DESCRIPTION

Following below are more detailed descriptions of various concepts related to, and implementations of, methods, apparatuses, and systems of managing AR experiences. The various concepts introduced above and discussed in greater detail below may be implemented in any of numerous ways, as the described concepts are not limited to any particular manner of implementation.

Example systems and methods of the present disclosure allow multiple users, with no prior relationship, to share content (e.g., documents, phone numbers, emails, messages, etc., or links thereto), and actions (e.g., “give a rating,” “fund our campaign,” “contact us,” etc.) by placing scene objects in the physical world. A user registers content in the physical world by “augmenting” the real world. In various implementations, users without technical expertise can easily create and share an augmented/mixed reality experience, by associating digital assets (files, videos, photos, text and URLs) and interactive objects (click-to-tweet, rating panel, surprise packages) to physical places and objects. Each augmented reality experience may be organized in layers, akin to a radio station: any user using an app on their device can “tune” to that layer, and uncover those objects on, for example, a 3D map, or through augmentation from the camera feed. In various implementations, the skills required to create a basic layer and add scene objects does not exceed the skills required to create a Twitter handle and tweet. Similarly, in some implementations, the skills required by a user finding content does not exceed the skills required to play a 3D game on a mobile device. A typical user may be a user of a mobile app who is using the app to find interesting content around him/her, or take some actions (e.g., connect with someone by accessing his/her LinkedIn profile on the spot), or collect items (e.g., a coupon). The user's motivation may be to make sure he/she does not miss out on opportunities, or uncover information that will help him/her optimize his/her time in a specific location, or make her more productive.

Editors of the app can create objects using their devices (e.g., their smart phones), via, for example, a mobile application or a web application, or programmatically via a platform API. Users may use the app to uncover and interact with objects to, for example, access an embedded link or other content by clicking the object, collecting the underlying asset, giving feedback (for instance, clicking on a star rating), etc.

An example augmented reality (AR) approach disclosed herein may include an AR application (“app”), which may be a camera-based app client that can be used, for example, to: display scene objects that may augment a visual view of a physical space and/or digital content (referred to as “digital assets”); manage interactions with scene objects; collect scene objects/digital assets in a virtual “backpack” for later access; select layers with which scene objects and digital assets are associated; etc.

In example versions, scene objects are the core graphical elements of the system. Scene objects may represent or be associated with/correspond to one or more digital assets that a user can see, collect, and/or interact with. Scene objects may hover, or be “attached” to a precise anchor in the physical world. Scene objects may be attached to physical anchors and can have one or more behaviors associated therewith. Scene objects can be associated to a geospatial location (latitude/longitude/altitude) coordinate, or attached to an image, a visual marker (such as a logo or QR code), a physical feature (such as a wall or floor), and/or sensory marker (e.g., triangulated beacon signals). In some embodiments, scene objects may be floating such that they are not associated with a particular physical object (or anchor). Attaching objects to a visual and sensory marker enables greater accuracy in positioning and discovering. In addition, visual markers offer the additional advantage of 1) indicating to a user that AR content is available, and 2) providing a branding opportunity. In some implementations, the scene object may include a field with a reference to the graphical object (3D or 2D) to use within a client app to represent the scene object in an augmented scene.

In certain implementations, the disclosed AR approach may involve an open, mixed reality service (MRS) (which may be implemented using, e.g., system 130) with a set of application programming interfaces (APIs), such as representational state transfer (REST) APIs, for adding or searching for AR content, layers, etc., based on location and/or physical features in a user's surroundings. An example system may store physical “anchors” and their associated virtual objects (which are presented relative to the anchors). The system may dynamically load/offload objects and anchors based on locations and/or layers. Using the APIs, objects can be attached to anchors programmatically (for instance, at a customer address). The system may also provide search capabilities to allow users to search for AR experiences. One or more APIs may return relevant AR experiences at any given location, for a specific theme, or during a specified time. AR experiences may be recommended at a user location or based on an interest. Layers based may be recommended based on a theme (e.g., informational videos, coupons, etc.). The system may enable activation of a layer based on, for example, scanning a physical marker (such as a QR code or physical object(s) in the user's surroundings).

An anchor may represent one or more attachment points to which one or more scene objects can be attached. Depending on the type of anchors, the device may attempt to track and adjust the attachment points for the tracked anchor in real time, based on sensory inputs. For instance, the attachment point for an image anchor may be adjusted dynamically based on a computer vision algorithm that will track and adjust the position of the image in the scene when the image or the camera moves. Scene objects may be positioned relative to or attached to an anchor in a coordinate system. The frame of reference may be, in various implementations, either geospatial (i.e., a combination of latitude/longitude/altitude), or Cartesian frame of reference (i.e., (X,Y,Z) in scene units). In some implementations, one scene unit may equal one inch, one foot, one meter, or any other unit of dimension.

Anchors provide a link between the physical word and the augmented world. They can represent any kind of sensory input that can lead to positioning a scene object around the user. For instance, an anchor could be a visual marker, or a triangulated Bluetooth signal. Anchors may be given a symbolic name (such as “main lobby,” “table 31,” “kitchen,” etc.), which can be used to add/associate scene objects to the anchors programmatically.

In some implementations, example anchor types may include the ones found in the following table:

| | | Coordinate system for | | |
|---|---|---|---|---|
| | Anchors | attached objects | Coordinate System Origin | Source |
| Built-in | real-world-center | geoSpatial | (lat, long, elevation) = (0, 0, 0) | Stationary |
| Built-in | scene-center | Cartesian | (x, y, z) = (0, 0, 0) | Stationary |
| Built-in | Body | Cartesian | Body position and rotation on | Adjusted (GPS) |
| | (locked to body) | | X and Z axis. Y = 1.2 units | |
| Built-in | Head | Cartesian | Head position and rotation on | Adjusted (GPS) |
| | (locked to head position) | | X and Z axis. Y = 1.7 units | |
| Dynamically created | Inage + ID | Cartesian | Image marker center (image center) | Adjusted |
| Dynamically created | 3d-surface + ID | Cartesian | Surface center | Adjusted (SLAM) |
| Dynamically created | Zone (geospatial center + range) | Cartesian | (lat, long, elevation) = (0, 0, 0) | Adjusted (GPS + SLAM) |

Example implementations of an MRS include a central server for creating and managing layers, querying layer information based on location, creating and managing anchors, creating and managing scene objects associated with (and presented with respect to) anchors, etc. An MRS service may have four types of clients: an app for creating, editing, and accessing AR experiences; a web client which may allow users to manage layers and scene objects; an admin web client for administrators of the MRS system who manage the system; and third-party devices such as AR glasses, connected cars, and other clients able to display AR content.

The example implementations of the present disclosure can provide a service that allows non-technical users to, for example, transform Uniform Resource Identifiers (URIs) into an actionable 3D model without knowledge of 3D modeling or app development. Multiple 3D objects may be combined by applying automatic placement of objects in space. The challenge of positioning 3D graphical elements in a coherent spatial arrangement is a significant barrier to augmented content development by non-technical users. A set of URIs may be registered in the physical world, lasting for a specified period of time. A URI that others have placed in the physical world may also be located. The user can automatically create an interactive augmented representation of those URIs so that users can open/view/collect the URIs without typing but instead through touch.

In various implementations, the system stores, retrieves, and positions augmented content based on a combination of sensory inputs to precisely register content in the physical world (relative to, e.g., a single anchor type). A geolocation tag may be used to enable content to be discoverable. The tag may provide coarse grain positioning of objects. One or more local anchor(s), such as images, surfaces, and triangulated communications signals, may be used for fine-grain positioning. In different implementations, a server (e.g., a cloud service) allows a user to store, search, and retrieve complete augmented experiences, which may include one or several 3D models, and a definition of the user interactions that are allowed with respect to those models (e.g., open a link, collect content, drag and drop, etc.). The location in the physical world where the augmented experience is approximately placed (latitude/longitude/elevation) may be provided. The augmented experience may be precisely attached to a set of physical features in the form of anchors (e.g., images, markers, QR code, bar code, triangulated Wi-Fi, Bluetooth signal, near-field communication (NFC) with one or more particular devices, vertical or horizontal surfaces, audio pattern, etc.). The augmented experience may also be precisely attached to a point relative to the receiving user (e.g., distance and position relative to feet, head, waist). A set of time windows during which the augmented experience is active/inactive may also be defined.

An example app running on a user device may allow users to create augmented experiences and register them in the physical world, at a location and with a range defining a zone where the experience is available. For example, user A may be able to create, configure, activate, and save an augmented experience. User B may then find, load, decode, view, and interact with the augmented experience created by user A. In example embodiments, this approach enables an augmented experience to be distributed individually to each person within a zone as well as a single physical location (such as a concert, conference, sports event).

According to some aspects, methods and systems of providing digital content in an augmented reality environment may involve a server that maintains one or more layers associated with a particular set of geographical coordinates, each layer corresponding to a content publisher/editor. The content publisher/editor, via a publisher/editor device, may transmit a request to the server, to provide a scene object for access (via a user device) on a layer. The request from the publisher/editor device may identify an anchor relative to which to present the scene object, presentation attributes identifying a manner in which to present the scene object, and access permissions identifying one or more rules according to which the scene object can be accessed or interacted with. The server may in response generate a AR asset identifying the scene object, the anchor, the layer, the geographical coordinates, the presentation attributes, the access permissions, and a digital asset corresponding to the scene object and/or a link to a location at which the digital asset is stored. An application executing on a client/user device of a user may, via the client/user device of the user, transmit a request to the server to identify scene objects associated with the layer. In response, the server may transmit the AR asset to the application, which may present the scene object on a display at a physical location associated with the anchor according to the presentation attributes and access permissions.

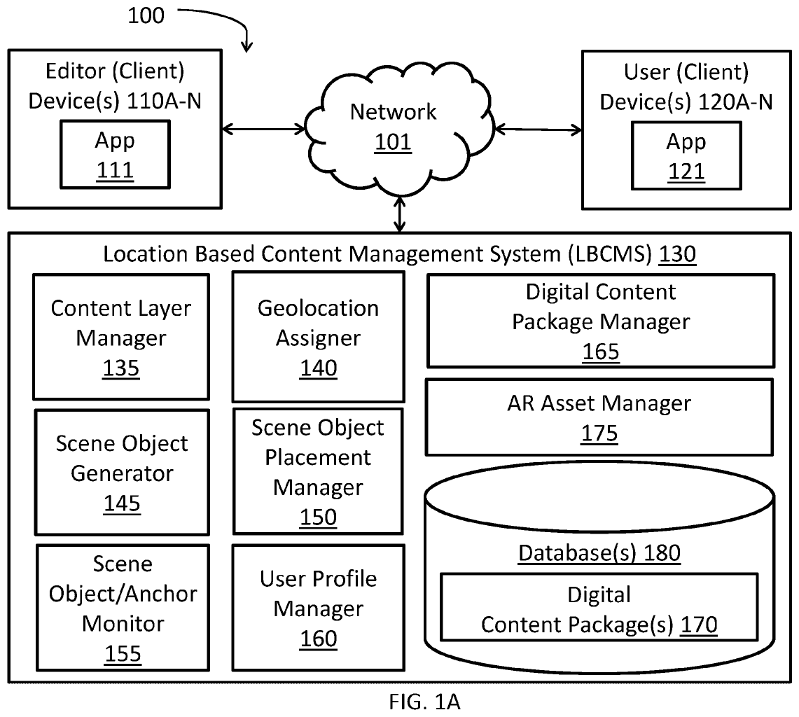

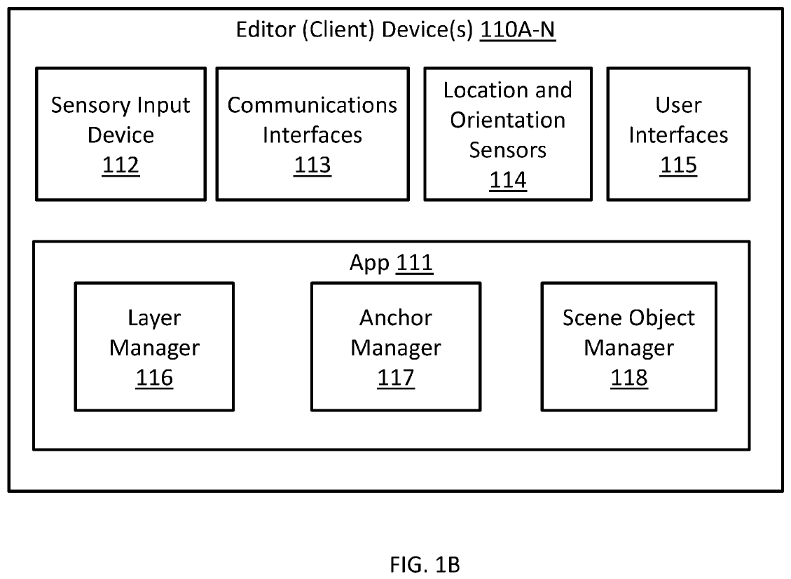

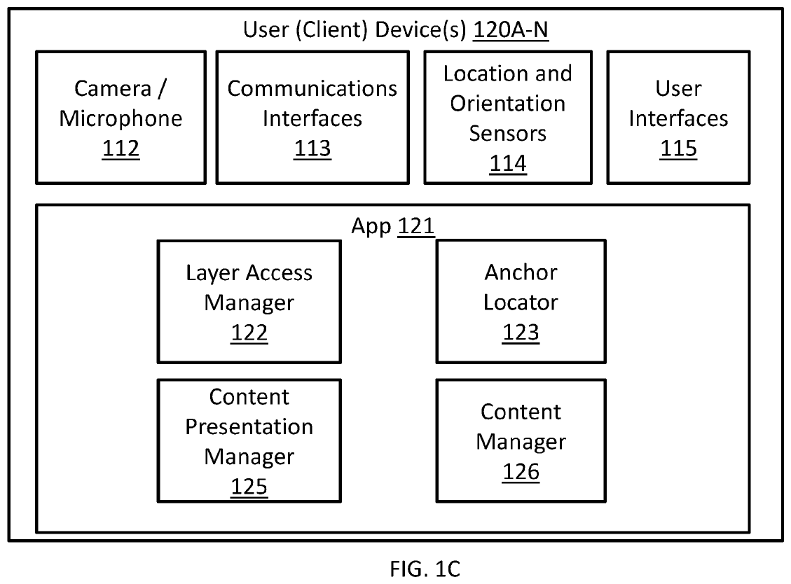

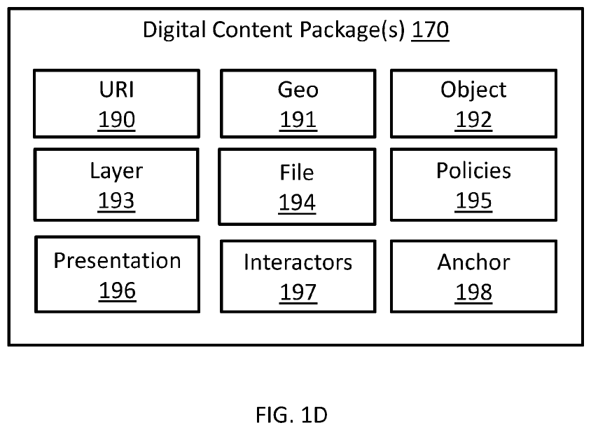

Referring now to FIG. 1A, FIG. 1A is a block diagram depicting one implementation of a computer networked environment 100 for allowing content publishers/editors, via editor devices 110, to design, create, and generate augmented reality (AR) experiences for users of user devices 120. The environment 100 includes at least one location based content management system 130. Although only one content management system 130 is illustrated, in many implementations, content management system 130 may be a farm, cloud, cluster, or other grouping of multiple data processing systems or computing devices.

The content management system 130, the editor device 110 and the user devices 120 each can include a processor and a memory as part of a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language.

The network 101 can include computer networks such as the internet, local, wide, metro or other area networks, intranets, satellite networks, other computer networks such as voice or data mobile phone communication networks, and combinations thereof. The content management system 130 of the system 100 can communicate via the network 101 with at least one editor device 110 and/or with at least one user device 120. The network 101 may be any form of computer network that relays information between the one or more editor devices 110, one or more user devices 120, the content management system 130, and one or more content sources. For example, the network 101 may include the Internet and/or other types of data networks, such as a local area network (LAN), a wide area network (WAN), a cellular network, satellite network, or other types of data networks. The network 101 may also include any number of computing devices (e.g., computer, servers, routers, network switches, etc.) that are configured to receive and/or transmit data within network 101. The network 101 may further include any number of hardwired and/or wireless connections. The user device 120 may communicate wirelessly (e.g., via WiFi, cellular, radio, etc.) with a transceiver that is hardwired (e.g., via a fiber optic cable, a CAT5 cable, etc.) to other computing devices able to access network 101.

The user device 120 and the editor device 110 can include desktop computers, laptop computers, tablet computers, smartphones, smart glasses and headsets, connected vehicles, personal digital assistants, mobile devices, consumer computing devices, servers, clients, digital video recorders, a set-top box for a television, a video game console, or any other computing device configured to communicate via the network 101. The client devices 110, 120 can be communication devices through which an end user can submit requests to receive content via the content management system 130. Additional details regarding the user device 120 and the editor device 110 are provided herein with respect to at least FIGS. 1B and 1C.

The content management system 130 can include at least one server. In some implementations, the content management system 130 can include a plurality of servers located in at least one data center or server farm. The content management system 130 can include at least one content layer manager 135, at least one geolocation assigner 140, at least one scene object generator 145, at least one scene object placement manager 150, at least one scene object monitor 155, at least one user profile manager 160, at least one digital content package manager 165, at least one AR asset manager 175 and at least one repository or database 180 storing one or more digital assets 170. Each component of content management system 130 can include at least one processing unit, server, virtual server, circuit, engine, agent, appliance, and/or other logic device such as programmable logic arrays configured to communicate with the database 180 and with other computing devices (e.g., the content publisher 110 and the client device 120) via the network 101.

Each component of content management system 130 can include or execute at least one computer program or at least one script. The identified components can be separate components, a single component, or part of one content management system 130 or part of two or more content management systems 130. The components can include combinations of software and hardware, such as one or more processors configured to execute one or more scripts.

The content layer manager 135 can be configured to generate and manage one or more content layers. A content layer is a logical construct that is assigned to or otherwise associated with one or multiple geolocations and ranges. The ranges can correspond to a particular distance from a particular geolocation. Furthermore, the content layer is assigned to a layer owner that owns the layer. The layer owner can be an entity that can control the type of content presented within the layer. The content layer manager 135 can be configured to only modify the content layer based on requests received from the content layer owner. In this way, content layer owners can retain control of the objects that can be displayed or otherwise presented within the particular content layer. In some embodiments, a layer owner can set various rules for the layer. For instance, the layer owner can request to configure the layer such that the layer cannot be editable by others. In other implementations, the layer owner can request to configure the layer such that the layer can be editable by others. In some implementations, the layer owner can request to configure the layer such that the layer can be accessed by anyone or limited to users to which the layer owner has granted access.

The content layer manager can be configured to receive a request from an editor device to create a new layer. The content layer manager can identify, from the request, a particular geolocation with which to associate the content layer. In some embodiments, the content layer manager and the geolocation assigner 140 (as described herein) can be configured to determine a geolocation from a request and assign the content layer to the determined geolocation. In some embodiments, the geolocation can be mapped to a physical location or entity, such as a building or venue. The request can identify the building or venue to which to assign the layer. In this way, when a user of the content management system requests to identify layers associated with a particular venue or entity, the content layer manager 135 can identify all of the layers that are assigned to otherwise associated with the particular venue or entity. In some embodiments, the content layer manager 135 may perform a lookup for a geolocation corresponding to the particular venue or entity to identify layers associated with the particular geolocation.

The geolocation assigner 140 can be configured to assign geolocations to one or more content layers, anchors, objects or other constructs associated with the content management system 130. As the content management system 130 receives requests from editors 110 to associate digital assets to a particular layer, the geolocation assigner 140 can assign a geolocation to the digital asset based on the geolocation assigned to the particular layer. Furthermore, the geolocation assigner can associate anchors at a particular venue or location to a geolocation associated with the particular venue or location. In this way, each anchor maintained by the content management system 130 is assigned to a particular geolocation.

The scene object generator 145 can be configured to generate one or more scene objects 192 (see FIG. 1D). Scene objects can include objects that can be displayed or otherwise presented within a field of view of the client device, such as the user device 120. The scene object generator can be further configured to generate one or more digital content packages 170 corresponding to respective scene objects 192. These digital content packages 170 may be linked to content/digital assets on one or more webpages belonging or otherwise accessible to users of the editor devices 110. The digital content packages 170 can include any content configured for display on or access via user devices 120. Example digital content packages 170 can include content or digital assets that include any combination of: one or more URLs to one or more files; videos; sounds; and/or web pages; video files; audio files; image files (e.g., photographs); messages (such as text messages and e-mail); a link to call a phone number or send a text via SMS; a coupon; a social networking link (e.g., LinkedIn, Facebook, Twitter, etc.); documents with text, images, presentations, spreadsheets, etc.; a feedback panel (e.g., a star rating); any 3D object (e.g., a holographic type of representation); and/or dynamic data. Additional details relating to a digital content package 170 is described herein with respect to FIG. 1D.

The scene object generator 145 can generate a scene object and the corresponding digital content package responsive to a request from an editor device 110. In some implementations, the editor device can communicate with the content management system 130 and transmit a request to generate a scene object or associate a scene object with a layer. The request can identify a URI or link to content/digital asset related to the scene object, a geographical location, a layer within which to present the scene object, a file corresponding to the scene object, one or more access policies according to which the scene object or corresponding file is accessible, one or more presentation attributes defining a manner in which the scene object is to be presented within a field of view of a user device, one or more interactors defining one or more interactions that can be performed on the scene object and an anchor to which the scene object is anchored such that when the anchor is detected within a field of view of a user device, the scene object can be displayed such that the scene object appears on or adjacent to the anchor. In some embodiments, the anchor may not be a visual anchor and as such, the object may become visible within a field of view responsive to the client device detecting that the anchor is present. Additional details relating to the digital content package are further described with respect to FIG. 1D. The digital content package 170 can further include one or more scripts that are designed to execute within an application executing on the user device such that the scene object is displayed within a field of view of the user device in accordance with the various presentation attributes, access policies and with the interactors identified within the digital content package 170.

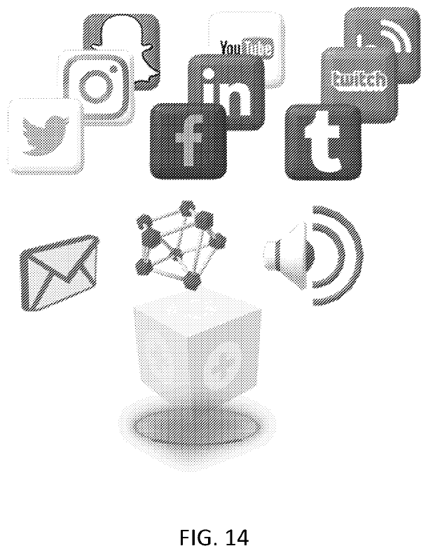

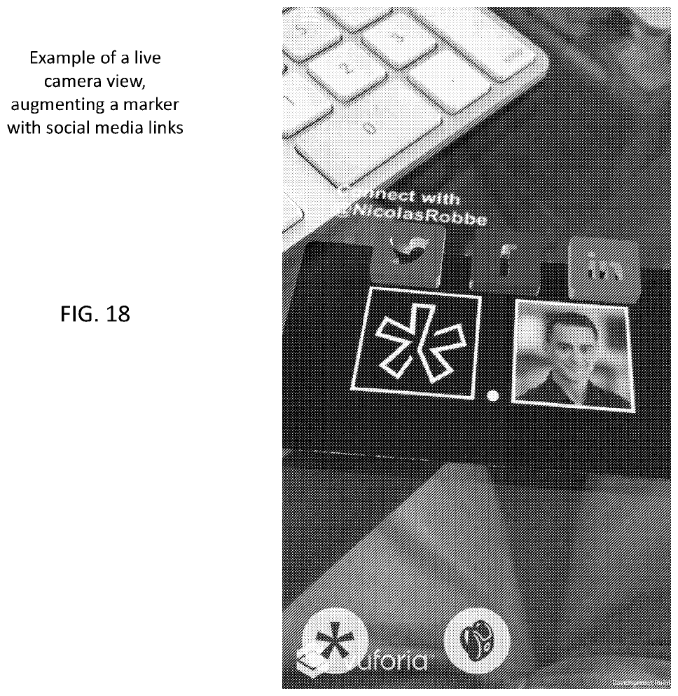

In some implementations, the scene object generator 145 may generate scene objects using predetermined templates or models. Scene objects may have visual characteristics that are defined according to predetermined templates or models. The scene object generator 145 can generate scene objects for presentation using a 2D or 3D model that is specific to a type of scene object. For instance, a scene object linking to a particular website or domain may be generated using a 2D or 3D model specific for that particular website or domain. In some implementations, the scene object generator 145 can determine a 2D or 3D model to use as a template for generating a scene object based on the type of content for which the scene object is being generated. As described further below, a link to a LinkedIn page may auto-select the LinkedIn logo and insert the picture associated with the LinkedIn page (see, e.g., FIGS. 14 and 18). Similarly, pasting an audio clip may auto-select the speaker icon (shown in FIG. 14 with wave lines representing sounds emitted from the speaker) as the scene object (or a portion thereof). As such, each predetermined template or model may dictate the manner in which a scene object is displayed.

The scene object placement manager 150 can be configured to manage the placement and presentation of scene objects generated by the scene object generator 145. The scene object placement manager 150 may place the scene object into a scene relative to a physical anchor. In some embodiments, the scene object placement manager 150 may place the scene object into a scene relative to a physical anchor such that the scene object is available for a specified time period. The time period can be defined by the editor of the layer. The scene objects, as well as the corresponding digital content packages 170 (e.g., the content that is accessible via interaction with particular scene objects 132), geolocations, access policies (including time periods), etc., can be saved in layers that are managed by content layer manager 135. Because layers, scene objects, and/or digital content packages 170 may be associated with (e.g., accessible when located at) certain geographical locations (during limited times, if specific times are specified for accessibility), the geolocation assigner 140 is configured to assign location indicators such as longitude and latitude coordinates (“long/lat”), addresses, landmarks, dates, time periods, etc., to layers, scene objects, and/or digital content packages 170. The scene object monitor 155 is configured to track scene objects as a user moves relative to the scene objects or within a geographic area, as further discussed below. The user profile manager 160 manages and maintains profiles of users (e.g., editors, consumers, content publishers, clients, etc.) and updates thereto.

The scene object placement manager 150 can be configured to manage the placement of scene objects within a field of view. The scene object placement manager 150 can be configured to parse a request from an editor 110 to identify one or more presentation attributes according to which to present the scene object. The presentation attributes can relate to the manner in which the scene object can be presented. In some embodiments, the presentation attributes can correspond to a type of anchor with which the scene object is to be presented. Additional details relating to the presentation attributes are provided below. Further, the scene object placement manager 150 can be configured to determine one or more access policies associated with the scene object that may control the presentation of the object. For instance, the access policies may include one or more rules that determine when (for instance, time of day, etc.) the object is available, the types of devices or end users to which the object is available, among others. The scene object placement manager can determine the presentation attributes or access policies associated with an object from a request from the editor. In this way, the editor can control the presentation and/or access of objects.

The scene object/anchor monitor 155 can be configured to track scene objects and anchors. The scene object/anchor monitor 155 can track scene objects and/or anchors by, for example, determining a number of times a scene object and/or anchor has been displayed within a field of view of one or more user devices. The scene object/anchor monitor 155 can track the number of times and the users who interact with the scene objects. In this way, the scene object/anchor monitor 155 can, for example, monitor the performance of each of the scene objects to determine engagement of the scene objects by specified groups of (or all) users. Furthermore, the scene object/anchor monitor 155 can be configured to monitor a number of times an anchor associated with a scene object has been identified via the application 121 executing on the user device and compare performance of various objects and anchors by comparing the engagement of the objects relative to the number of times anchors have been identified.

The user profile manager 160 can be configured to manage user profiles. The profiles can be of editors that own layers or of end users that access content via the content management system 130. The user profile manager 160 can create user profiles for each user and store them in the database 180. Each user profile can be associated with objects. In the case of a user profile of a layer owner, the user profile can store an association between the owner, the layer and the one or more objects configured for presentation within the layer. In the case of a user profile of an end user, the user profile can store an association between the owner and one or more objects the user has collected or retrieved from one or more layers. In addition, the user profile can store other information relating to the user's actions at various geographical locations, layers and anchors, among others.

The digital content package manager 165 can be configured to generate and manage digital assets. The digital content package manager 165 can be configured to generate a digital asset for each object that is associated with a layer. The digital content package manager 165 can be configured to identify requests from layer owners to associate objects to layers and can use information included in the request to generate one or more digital assets. As described with respect to FIG. 1D, the digital content package manager 165 can maintain an association between each object, layer, geographical location, anchor, presentation attributes, access policies, among others. In some embodiments, the request can identify a URI or file to associate to an anchor. The digital content package manager165 can identify from the request, the layer and the geographical location. The request can further include presentation attributes and access policies identified by the content layer owner.

The AR asset manager 175 can be configured to generate one or more AR assets. An AR asset may include one or more digital content packages corresponding to a layer as well as a script to enable an application executing on a user device to present scene objects corresponding to the digital assets of the layer within a field of view of the user device. The AR asset can be layer specific and can be updated by the AR asset manager 175 as a content layer owner updates the content layer. In some embodiments, the AR asset can get updated when a new scene object is associated with the content layer. The AR asset manager 175 can be configured to generate a new AR asset or update an existing AR asset to include one or more digital assets corresponding to the scene objects associated with the layer. Responsive to a request from a user device to access a layer, the content management system 130 can be configured to identify the AR asset corresponding to the layer and provide the AR asset to the user device. As will be described herein, the user device can receive the AR asset and present scene objects within a field of view of the user device via the application 121 executing on the user device 120.

The one or more repositories or databases 180 of the content management system 130 can be local to the content management system 130. In some implementations, the databases 180 can be remote to the content management system 130 but can communicate with the content management system 130 via the network 101. The databases 180 can include the scene objects to be provided to users as part of AR experiences. In some implementations, the databases 180 can include the scene objects as well as digital content packages 170 provided by the content publishers 110. In certain implementations, the databases 180 can include the digital content packages 170 provided by the content publisher/editor 110 and the reference addresses identifying respective digital packages 170 (e.g., URIs or other identifiers of locations of digital assets 170). In other example implementations, the databases 180 can include 2D/3D models for generic scene objects, and the data for generating scene objects using the models for specific types of content. The databases 180 can also include a combination of the scene objects (and/or models therefor), the digital packages 170, the layers with which scene objects are associated, geolocations for layers/scene objects, etc.

Although the above discussion identifies a set of modules that perform specified functions, in other implementations, the above (and other) functions could be performed by any module in the system. Functions performed by the system could thus be redistributed among the modules of the system, consolidated into fewer modules, or expanded such that they are performed by a greater number of modules than illustrated above.

The content management system 130, the editor devices 110, and the user devices 120 may each also include one or more user interface devices (e.g., user interfaces 115, 125). In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the content management system 130, the editor devices 110 and the user devices 120 (e.g., a built-in display, microphone, etc.) or external to the housing of content management system 130, the editor devices 110 and the user devices 120 (e.g., a monitor connected to the client devices 110, 120, a speaker connected to the client devices 110, 120, etc.), according to various implementations. For example, the editor devices 110 and the user devices 120 may include an electronic display, which visually displays content from a camera respectively, and/or from the content management system 130 via the network 101. In some implementations, a third-party content provider can communicate with the content management system 130 via the network 101.

The editor device 110 can include servers or other computing devices operated by, for example, individual users and/or a content publishing entity to provide content used to generate digital packages 170 via the network 101. For instance, the editor device110 can be used by an entity wishing to share media (photos, videos, advertisements, coupons, information, hyperlinks, etc.), such as a company that wants to provide content about the company via an AR experience. The AR experience can include scene objects (virtual objects which can be placed into AR scenes) configured to indicate the availability of digital packages 170 provided or made available via the editor device 110. The entity can be non-technical (i.e., without a background in software engineering), such as a social media manager in a marketing group. The entity, as editor, can be a layer owner who is able to add content to be shared with users on the layer.

Referring to FIG. 1B, the client device 110 of a content publisher/editor can include one or more sensory input devices 112, one or more communication interfaces 113, one or more location and/or orientation sensors 114, and one or more user interfaces 115. The sensory input devices 112 can include a camera, a microphone, a keyboard or other tactile-based input device, among others. The communications interfaces can include one or more modules for establishing communications with the location based content management system 130. The location and/or orientation sensors 114 can include a GPS sensor for determining GPS coordinates, an interior space sensor device for determining a position of a device within a physical space, a gyroscope, an accelerometer, a compass or any other sensor for determining a location or orientation of the client device 110. The user interfaces can include a display screen, an audio interface device such as a speaker, among others.

The client device 110 can further include one or more processors and a memory. The client device 110 can include an application 111 including computer-executable instructions stored on the memory. The application 111 can include, for example, an Internet browser, a mobile application, or any other computer program capable of executing or otherwise invoking computer-executable instructions processed by the client device 110. Application 111 may interface with one or more components of client device 110 to provide the user of the client device 110 with an AR experience, using sensory input devices 112 (which provide imagery and/or sounds, real-time or otherwise, captured from the surroundings of the user), sensors 114 (which may provide data on, e.g., orientation, location, etc., of the client device 110), and a display (which can be used to provide the user with scene objects and digital assets 170) and other user interfaces 115 (such as touchscreens or other input devices), speakers, etc. In certain implementations, editor devices 110 are mobile computing devices such as smartphones and tablets.

The application 111 can be configured to cause the client device to enable a user of the client device to communicate with the content management system 130. The application 111 can include a layer manager 116, an anchor manager 117 and a scene object manager 118.

The layer manager 116 can be configured to generate requests at the client device 110 to generate and/or modify one or more layers. The layer manager 116 can provide a user interface through which a user can request to generate a layer. The layer manager 116 can generate a request identifying a name of a layer and a geolocation associated with the layer and/or a physical venue or entity associated with the layer. The request can be transmitted to the content management system 130 where the layer can be generated by the content layer manager. The layer manager 116 can be configured to set access policies to the layer generated by the content management system 130. The access policies can define which users can access the layer, as well as define one or more rights or permissions associated with the layer itself as well as with scene object or other digital content packages within the layer or associated with the layer.

The anchor manager 117 can be configured to locate one or more anchors in a physical space. In some embodiments, the anchor manager 117 can receive an image stream from a camera 112 of the client device and apply image processing to the image stream to identify one or more candidate anchors. Examples of anchors that can be identified include flat surfaces, objects, among others. In addition, the anchor manager 117 may utilize one or more other sensors of the client device to identify anchors, such as a microphone for identifying sounds, a wireless communications module for detecting Bluetooth or WiFi signals, among others. The anchor manager 117 can be configured to generate a list of anchors available for a given physical space and make them available to the layer. In this way, a user may request to associate a scene object to a particular anchor included in the list of anchors identified by the anchor manager 117. In some embodiments, the anchor manager 117 can provide the list of anchors to the content management system 130 such that the content management system 130 can update a list of anchors for a given physical venue or space, enabling discovery of new anchors and sharing these new anchors with other layer owners.

In some embodiments, the anchor manager 117, which is configured, in certain implementations, to receive data from components of the client devices 110 (such as imagery from camera 111, location and orientation data from sensors 114, etc.) and identify physical objects in its surroundings which could serve as anchors for scene objects. For example, the anchor manager 117 may identify horizontal surfaces like tabletops, vertical surfaces like walls (or items like pictures and paintings hanging on walls), etc. This may be accomplished, in various implementations, using image/pattern recognition algorithms. The application 111 may request that the user move the client device 110, 120 to allow the application 111 to confirm the identity of physical objects by determining their appearance from multiple angles. In editor devices 110, the anchor manager 117 may be useful, in certain implementations, for determining available anchors with which scene objects can be associated.

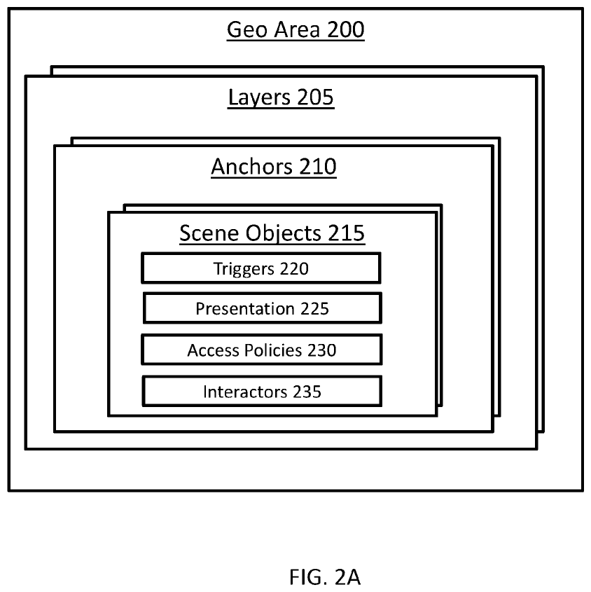

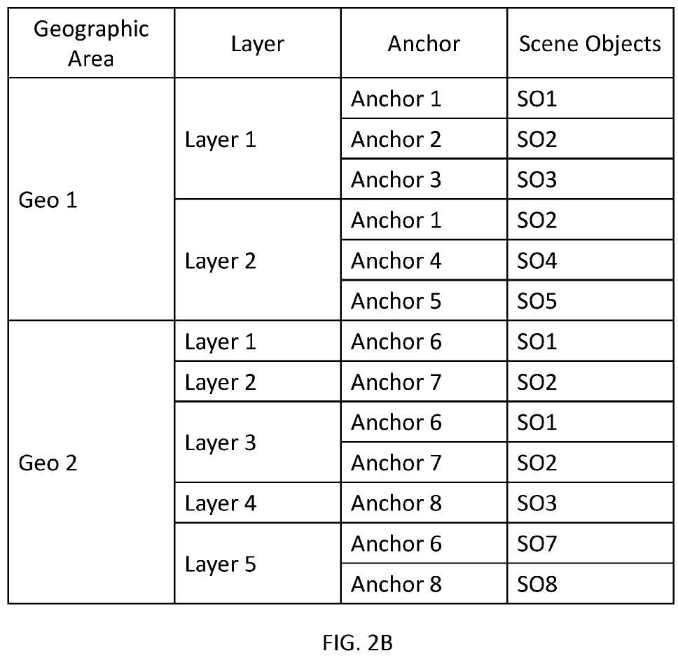

In some implementations, the anchor manager 117 can be configured to identify one or more physical anchors in a space from a stream of images. The anchor manager 117 can be configured to store the identity of each of the physical anchors identified from the stream of images and maintain a spatial mapping of the physical anchors. In this way, as the user device captures images of a space repeatedly, the anchor manager 117 can quickly identify the previously identified physical anchors. In some implementations, the anchor manager 117 can store the anchors and their spatial mapping information in a data structure that can be accessed by the application across multiple layers. In this way, as a user accesses multiple layers within the same physical space, the application does not need to identify the one or more physical anchors in the physical space but rather can rely on the data structure maintaining a cache of the physical anchors. Additional details regarding the overlap of anchors across layers is depicted in FIG. 2B.

The application 111 can also include a scene object manager 118, which is configured, in certain implementations, to maintain associations of scene objects with corresponding anchors, layers, and/or geographical locations. In editor devices 110, the scene object manager 118 may be useful, in certain implementations, for linking a selected scene object with a selected anchor, with the editor's layer, and/or with the digital content package which can be accessed via the scene object. In user devices 110, the scene object manager 118 may be useful, in some implementations, attaching the scene object with an anchor in augmenting the physical objects in the user's surroundings.

The application 111 can be configured to generate requests to the content management system 130 to associate content with anchors within a physical space for a given layer. The content can include a link to a resource online, a file such as an image file, a video file or an audio file, a presentation file, a document, among others. The application can transmit the content to the content management system 130 along with one or more presentation attributes indicating how the content is to be displayed, one or more access policies indicating how the content is to be accessed, and one or more interaction policies indicating various types of actions that can be performed on the content. As described herein, the content management system can receive that request and generate a scene object and a corresponding digital content package that can be associated with the anchor in the physical space as well as the layer, which can then be used for presenting the content to a user that accesses the layer to which the content was associated.

Referring to FIG. 1C, the client device 110 of a user requesting to access content on a layer of the content management system 130 can include one or more sensory input devices 112, one or more communication interfaces 113, one or more location and/or orientation sensors 114, and one or more user interfaces 115. The sensory input devices 112 can include a camera, a microphone, a keyboard or other tactile-based input device, among others. The communications interfaces can include one or more modules for establishing communications with the location based content management system 130. The location and/or orientation sensors 114 can include a GPS sensor for determining GPS coordinates, an interior space sensor device for determining a position of a device within a physical space, a gyroscope, an accelerometer, a compass or any other sensor for determining a location or orientation of the client device 120. The user interfaces can include a display screen, an audio interface device such as a speaker, among others.

The client device 120 can further include one or more processors and a memory. The client device 120 can include an application 121 including computer-executable instructions stored on the memory. The application 121 can include, for example, an Internet browser, a mobile application, or any other computer program capable of executing or otherwise invoking computer-executable instructions processed by the client device 110. Application 121 may interface with one or more components of client device 120 to provide the user of the client device 110 with an AR experience, using sensory input devices 112 (which provide imagery and/or sounds, real-time or otherwise, captured from the surroundings of the user), sensors 114 (which may provide data on, e.g., orientation, location, etc., of the client device 120), and a display (which can be used to provide the user with scene objects and digital content packages 170) and other user interfaces 115 (such as touchscreens or other input devices), speakers, etc. In certain implementations, the user device 120 can be mobile computing devices such as smartphones and tablets.

The application 121 can be configured to cause the client device to enable a user of the client device to communicate with the content management system 130. The application 121 can include a layer access manager 122, an anchor locator 123, a content presentation manager 125 and a content manager 126.

The layer access manager 122 can be configured to generate requests at the client device 110 to access one or more layers. The layer access manager 122 can provide a user interface through which a user can request to access a layer. The layer access manager 122 can identify a current location of the client device and transmit a request to the content management system 130 identifying the current location of the client device. Responsive to the request, the content management system 130 can determine one or more layers associated with the current location via geocoordinates and provide, to the layer access manager 122 via the client device 120, a list of layers that are accessible to the user device. Although additional layers may be associated with the current location of the client device, due to access policies of the layers, some layers may not be made visible to the client device and therefore, not included in the list of the layers.

The layer access manager 122 can be configured to present a list of layers to the client device and can receive a request to get access to content associated with a particular layer included in the list of layers available to the client device. Responsive to receiving a selection via the application 122, the application can cause the client device to transmit a request to the content management system 130 to provide one or more AR assets corresponding to the layer. The AR assets can include one or more digital content packages 170 and can be configured to be stored in the application 122.

The anchor locator 123 can be configured to locate one or more anchors in a physical space. The anchor locator 123 can operate in a manner similar to the anchor locator 117 of the application 111 configured for the editor device 110. In some embodiments, the anchor locator can receive an image stream from a camera 112 of the client device 120 and apply image processing to the image stream to identify one or more candidate anchors. Examples of anchors that can be identified include flat surfaces, objects, among others. In addition, the anchor locator may utilize one or more other sensors of the client device to identify anchors, such as a microphone for identifying sounds, a wireless communications module for detecting Bluetooth or WiFi signals, among others. The anchor locator 123 can be configured to generate a list of anchors available for a given physical space and make them available to the layer. In this way, a user may request to associate a scene object to a particular anchor included in the list of anchors identified by the anchor locator. In some embodiments, the anchor locator can provide the list of anchors to the content management system 130 such that the content management system 130 can update a list of anchors for a given physical venue or space, enabling discovery of new anchors and sharing these new anchors with other layer owners.

In some embodiments, the anchor locator 123, which is configured, in certain implementations, to receive data from components of the client devices 110 (such as imagery from camera 111, location and orientation data from sensors 114, etc.) and identify physical objects in its surroundings which could serve as anchors for scene objects. For example, the anchor locator 123 may identify horizontal surfaces like tabletops, vertical surfaces like walls (or items like pictures and paintings hanging on walls), etc. This may be accomplished, in various implementations, using image/pattern recognition algorithms. The application 121 may request that the user move the client device 110, 120 to allow the application 121 to confirm the identity of physical objects by determining their appearance from multiple angles.

In some implementations, the anchor locator 123 can be configured to identify one or more physical anchors in a space from a stream of images. The anchor locator 123 can be configured to store the identity of each of the physical anchors identified from the stream of images and maintain a spatial mapping of the physical anchors. In this way, as the user device captures images of a space repeatedly, the anchor locator 123 can quickly identify the previously identified physical anchors. In some implementations, the anchor locator 123 can store the anchors and their spatial mapping information in a data structure that can be accessed by the application across multiple layers. In this way, as a user accesses multiple layers within the same physical space, the application does not need to identify the one or more physical anchors in the physical space but rather can rely on the data structure maintaining a cache of the physical anchors. Additional details regarding the overlap of anchors across layers is depicted in FIG. 2B. In some implementations, anchor locator 123 can be used to provide information to underlying toolkits (such as ARKit by APPLE, Inc.) to configure the toolkits for the specific anchor the application is to track.

The content presentation manager 125 of the application 121 can be configured to manage and handle presentation of content within a user interface managed by the application. In some implementations, the application can be configured to present images captured by a camera of the client device 120 within the user interface 115. Responsive to the anchor locator 123 identifying an anchor within a portion of the images displayed, the content presentation manager 125 can be configured to identify the anchor, identify one or more scene objects included in the AR asset corresponding to the layer and present the scene objects on or adjacent to the anchors in accordance with the presentation attributes associated with the scene object. The content presentation manager can be configured to track the anchors within the display and adjust the position of the scene objects relative to the anchors as the camera and/or the client device moves thereby adjusting the position of the anchor within the field of view. The content presentation manager 125 can present the scene object by adjusting the size of the scene object based on one or more parameters associated with the camera, for instance, the zoom level of the camera, the orientation of the client device, among others. The content presentation manager can further identify one or more presentation attributes of the scene object and adjust the presentation of the scene object dynamically based on the presentation attributes. In addition, the content presentation manager 125 can identify one or more interactors associated with the scene object from the digital asset corresponding to the scene object and present one or more interactor elements for display to enable a user to interact with the scene object. Details regarding the interactors are provided herein.

The content manager 126 of the application maintains a data structure that includes identifiers corresponding to the objects that a user has selected to store on the device. A user may interact with a plurality of objects within a layer or across multiple layers and may, via the application, select to store one or more of the objects. The content manager 126 can receive the request to store an object, identify the object requested to be stored and update the data structure including an identifier of the object. In this way, a user can access the objects the user has stored via the application at a later time even if the user/client device 120 is not within the geographical location with which the object was associated and placed. The content manager 126 may maintain the access policies of the object within the data structure such that if the object has an access policy that restricts access to the content when the client device is not within the geographical location identified by the access policy, the content manager 126 can restrict a user's ability to access or open the content. Additional features of the content manager 126 are provided herein when referencing a backpack.

Referring to FIG. 1D, each digital content package 170 may be classified, identified, or managed using various attributes or properties. For example, a digital content package 170 may be identified or associated with URI 190, a field or indicator that identifies a location (e.g., a location in memory, a database or a location therein, a URL, etc.) where the digital content package 170 is stored. The location identified by URI 190 may be local or remote. URI 190 may be used by, for example, the content management system 130 and the editor device 110 to keep track of a memory location, database, computing device, etc., at which the digital resource 194 is stored and from which the digital resource 194 may be retrieved. In certain implementations, URI 190 may be stored as part of the digital content package 170 if the digital content package 170 does not include the digital resource itself but instead identifies how (from where) the digital resource 194 may be accessed/retrieved. In some implementations, parts of a digital content package 170 may be located in different locations, and URI 190 may identify multiple sources for the different parts of digital content package 170.

A geographical location identifier 191 of a digital content package 170 is a field or indicator identifies a geographical location (of client device 120) from which the digital content package 170 is accessible by a user. In certain implementations, content management system 130 may include a geographical location identifier 191 in an AR asset as a field (associated with a digital content package 170 or its URI 190) that indicates physical locations from which the client device 120 may access the digital content package 170. In certain implementations, an application 121 running on a client device 120 may compare (via, e.g., a scene object association manager 127) the present location of the user device 120 (determined using, e.g., a GPS device 114) with the geographical location identifier 191 field to determine whether a digital content package 170 is accessible to the client device 120 from the current location.

Object 192 is a field or indicator that may identify a scene object with which the digital content package 170 is associated and via which a digital content package 170 or the resource 194 is accessible. Content management system 130 and/or an application 121 running on a user device 120 may, for example, maintain associations between scene objects and digital content packages 170 using one or more fields of object 192. In some implementations, application 111 running on client device 120 may (e.g., via scene object manager 118) include a value in an object 192 field to indicate that a digital content package 170 being uploaded or otherwise provided via the client device 110 is associated with a selected scene object. Object 192 may also be used by application 121 of client device 120 (e.g., by scene object association manager 127) to confirm that a digital content package 170 is associated with a selected or collected scene object.

A layer 193 may include one or more fields that identify the layer with which the digital content package 170 is associated, and on which the digital content package 170 is accessible. In some implementations, content management system 130 may, based on inputs received via application 111 during the process of designing and/or editing an AR experience, generate an AR asset with a layer field 193 that associates the digital content package 170 with the layer being created. In certain implementations, the layer 193 may include fields used by, for example, layer manager 128 to identify to the user device 120 which digital content packages 170 are available once a layer is selected via application 121.

A file 194 field may include filenames and save locations of files (e.g., AR assets) that may contain the digital content package 170 that is presented via the associated scene object. This may be used by, for example, content management system 130, for example, in generating AR assets to be sent to user devices 120. This may also be used by application 121 to keep track of AR assets and their content.

A set of policies 195 in one or more fields may identify under what conditions a digital content package 170 is accessible. The fields of policies 195 may be selected via application 111 running on client device 110 in designing an AR experience. Policies 195 may also be used by application 121 running on client device 120 to determine (based on, e.g., inputs from camera/microphone 121, sensors 114, and user interfaces 125) whether conditions have been satisfied. For example, a policy 195 (which may be included in an AR asset sent to a user device 120) may identify a time period during which a digital content package 170 is accessible.

Presentation attributes 196 include fields or indicators that identify how a digital content package 170 is presented in a scene augmented with scene objects. Presentation attributes 196 may be selected via an editor client device 110. In some implementations, content management system 130 may apply default presentation attributes that may be changed via client device 110. Presentation attributes 196 may also be used, for example, by content presentation manager 129 of application 121 to determine how the scene object is to be presented on the display of user device 120. An example presentation attribute 196 includes one or more rotatability fields indicating to application 121 whether the scene object should be rotated such that its front side continues to face the client device 120 as the client device 120 is moved with respect to the scene object. The rotatibility field of presentation attributes 196, using one or more values in one or more fields, may indicate, for example, that a digital content package 170 (such as an image or video) rotates up/down (e.g., rotates along a horizontal axis such that a forward-facing side of the digital content package 170 faces up or down as the client device 120 moves above or below the scene object) and/or rotates left/right (e.g., rotates along a vertical axis such that the forward-facing side of the digital content package 170 faces leftward or rightward as the client device 120 moves to the left or right of the scene object. The rotatability may thus be indicated as being “fully rotatable” (i.e., the digital content package 170 is rotated in all axes to keep the digital content package 170 facing forward) or limited to identified axes (such that it has limited rotatability).

A set of interactors 197 (i.e., interaction behaviors) may include fields that can be used to identify how a user may interact with the digital content package 170 (such as the ability to enlarge/shrink, rewind or fast forward, collect in a backpack, etc.). In certain implementations, a content management system 130 may receive from an editor device 110 selections that determine or identify interaction behaviors, and the content management system may populate one or more fields of interactors 197. Application 121 (via, e.g., content presentation manager 129) may, in some implementations, use values in the fields of interactors 197 to determine how user interfaces 125 may be used to view, collect, etc., the corresponding digital content package 170 received in an AR asset. An example interactor 197 indicates that application 121 allows the content/resource associated with the scene object to be “collected” in a backpack for access at another time.

An anchor 198 may include one or more fields or values that identify a physical object (in the case of a visual anchor) with which a digital content package 170 is associated via a scene object. A content management system 130 may, for example, include one or more values field in an AR asset to associate digital content packages 170 with anchors. This may allow, for example, application 121 to search for digital content packages 170 based on an anchor (which may have been identified using anchor locator 126) as well as other criteria (such as a scene object).

FIGS. 2A and 2B provide logical representations of associations between geographic areas, layers, anchors, and scene objects that may be maintained by, for example, content management system 130. For a given geographic area having latitude/longitude coordinates, the content management system can associate one or more layers to a geographic area. Two different layers can include (reuse) the same anchors and scene objects because different editor devices 110 (via application 111) can place their digital content packages at the same anchors and present their digital resources via the same scene objects. However, a fixed anchor (i.e., one that generally does not change physical locations, such as the wall of a building) cannot be in multiple geographic areas.

For example, each geographic area/region 200 (i.e., locations in the physical world) may be identified (by a content management system) by a set of geographic coordinates, addresses, intersections, landmarks, etc. The area 200 may be defined by a tile that is delineated by, for example, a rectangular perimeter. The rectangular tile may be an area that constitutes the basic mechanism to load and offload scene objects and map data to and from the client app. As the user moves into the physical world, tiles may be loaded around the user's location. In some implementations, tiles can be placed in a local cache. A “map” may be a high-level environment for content like land use, roads, water, and/or buildings. The map is typically used for providing orientation to users. Maps may be loaded dynamically using tiles, and centered around the user's current latitude/longitude position.

For each area 200, the content management system may make one or more layers 205 accessible while a user device is located in the area 200. A user may, via application 121 (with layer manager 128) running on his or her user device, see a list of layers 205 that are available. In some implementations, this may be accomplished by application 121 retrieving a list of layers associated with a geographic region 200 (in, e.g., a database structured as represented in FIG. 2B). In certain implementations, content management system 130 may push a list of layers to user devices 120 once content management system 130 receives (from user device 120) data on physical location (e.g., latitude and longitude coordinates) obtained using a GPS or other location sensor 114 of the user device 120. Alternatively or additionally, user devices 120 may search fields of geographical location identifier 191 included in AR assets (which may be saved locally on the user device 120) to obtain a list of associated layers.

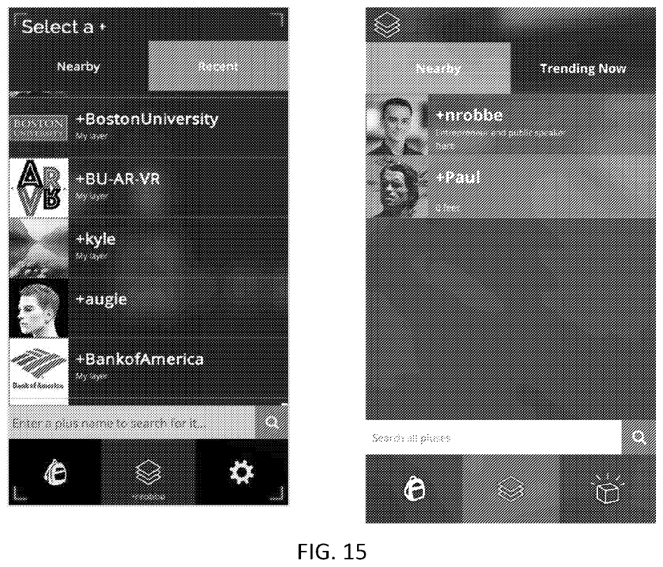

In the example list illustrated in FIG. 15, a user may be able to “tune in” to layers saved with names starting with, for example, a plus (“+”) or other character, followed by such names/labels as “BostonUniversity,” “BU-AR-VR,” “kyle,” “augie,” and “BankofAmerica.” Additional examples include: +BestEastern (e.g., a hotel chain can leave a welcome “virtual package” in each room, with links, coupons, useful numbers, etc.); +GoldenDonuts (e.g., a fast food chain can place time-limited coupons at the location of selected potential customers); +JSmith (e.g., a presenter at a conference can augment his slides with a tweet-now button, his contact details, and a button to collect the slides for later access); +btt (e.g., a telecommunications provider creates a personalized support package with numbers to call, and troubleshooting steps, for each of their customers, and attach/anchor it to their Wi-Fi router or set-top box); and +Alohalsland (e.g., a city tourism board can place virtual coins and rewards around the city).

Content management system 130 may associate a set of anchors 210 with each layer 205. Anchors 210 may be used by, for example, user devices 120 to identify physical objects relative to which scene objects are presented to user devices 120 accessing the layer 205 via application 121. In some implementations, application 111 (via anchor locator 116, scene object manager 118, and layer manager 116) may be used to create and define a layer 205 that identifies one or more anchors 210 in the physical world (each of which can be associated with a scene object). Content management system 130 may maintain layers 205 defined via multiple editor client devices 110, and for each layer 205, associate one or more anchors 210. Anchors 210 can be associated with one or more layers 210, as discussed above in the context of FIG. 2B. In some implementations, an anchor 210 is a logical construct that represents a physical object within a physical space to which scene objects can be attached such that scene objects can be presented within a display of the client device relative to the anchor. Layers 205 are analogous to “stations,” “channels,” or “frequencies,” and a user is able to “tune in” to the layers 205 via his or her device if the user is physically close enough to the anchors 210 located in the area 200. A layer 205 provides a communication method to indicate to others that augmented content is available at, for example, a particular location and/or at a given time.

In example implementations, an anchor defines a point in space (vector3) and orientation (quaternion) which can be located by an application running on a client device. In some implementations, content management system 130 may define a set of available anchors (using, for example, map data or imagery available for a geographic area) that can be used by editor client devices 110 without configuration. Custom anchors (like a trackable image) can also be created by a user via client devices 110. In some implementations, anchors may be identified by a URI (e.g., anchorType. {anchor-subtype} . . . {anchor-name}), such as: image.ku.nrobbe (image, kudan, id to track=nrobbe); realworld.origin; body.head; and body.hip.

In example implementations, client devices 110, 120 may use sensors/devices available to the user device 110, 120, such as a global positioning system (GPS) device and other location and orientation sensors 114, camera and microphone 112, Bluetooth, Wi-Fi, and other communications interfaces 112, or other devices for receiving real-world inputs that allow an anchor or trigger to be found (when the user device enters the applicable geographic area), tracked (while the user remains in the applicable geographic area), and lost (if the user leaves the applicable geographic area). When tracked, anchors create a position in world space, and define a local coordinate system depending on their type (e.g., Cartesian, geospatial). Anchors can have a 3-axis position, 3-axis rotation, and a scaling factor. Scene objects can then be positioned relative to their anchor referential.

Client devices 110, 120 may detect specific networks, devices, signals, etc., using communications interfaces 113. Because signals tend to have limited ranges, the ability of a client device 110, 120 to detect the signals may be indicative of the presence of the client device 110, 120 at a specific location or in the vicinity of one or more sources of the signals. Specific Bluetooth, Wi-Fi, and other signals can thus be used as triggers or prerequisites for the presentation of a scene object or accessibility of certain resources. At times, a client device 110, 120 may not be able to detect its geographic location to determine whether it is located in a geographic area in which a layer is accessible because its GPS device is located somewhere where it is not able to function (e.g., in the basement of a building). The presence of, for example, a particular Wi-Fi signal (which may be made available via specific routers of, e.g., a hotel, conference center, museum, etc.) may be used to indicate that the client device 110, 120 is located at the hotel, conference center, museum, or other geographic area. In some implementations, this may allow content publishers to provide, for example, attendees of a conference with content that is relevant to a presentation, such as slides, audio recordings, videos, images, etc. In some implementations, the signals may be used to define alternative geographic areas in which anchors may be located and associated with scene objects for access to relevant content.

In various implementations, real-world anchors may use a geospatial coordinate system. Scene objects may attach to that anchor by providing coordinates that include latitude, longitude, and elevation: latitude may be defined as a floating point number with six significant digits of precision, between 90 and −90 degrees; longitude may be defined as a floating point number with six significant digits of precision, between 180 and −180 degrees; and elevation may be defined as a floating point number with three significant digits of precision, as, for example, meters above local ground level (or below in case of negative values). Other anchors may use a Cartesian coordinate system. Scene objects attach to such anchors by providing a vector3 (X, Y, Z) in scene units. The vector may be used to position the scene object relative to the anchor.

Anchors may, in certain implementations, be images. Image recognition algorithms, which may be part of anchor locator 116 of application 111, may work on flat, two-dimensional (2D) inputs (e.g., a camera feed). When an image is detected, the device (e.g., smartphone) could either be close to a small image, or far from a large image. In certain implementations, it may be determined whether the user is close to a small image or far from a large image using one or more of, for example: positioning data from the user device; available map data; recognition of the object's surroundings to consider the object in the context of what is located in the vicinity of the object (e.g., relative to the height of a person, the size of a recognized landmark, the dimensions of a vehicle, etc.); etc.

In certain implementations, the content management system 130 may create a database of anchors (based on, e.g., anchors designated by users creating AR experiences) from which others can choose to tag physical places. Anchors may have been located by client devices 110, 120 (via anchor locator 116, 126 of application 111, 112) and transmitted to content management system 130. To that end, an anchor associated to a place may also be referenced in a tile. Tile numbers may be calculated using a standard approach based on latitude, longitude and zoom. For loading anchors to enable place tagging, a unique tile index may be calculated based on latitude, longitude and zoom level (i.e., size of bounding box). Anchors for a tile index may be requested and returned. (See, e.g., “slippy map tilenames” at https://wiki.openstreetmap.org/wiki/Slippy map tilenames.)

Each anchor 210 in a layer 205 can have associated therewith one or more scene objects 215 to be provided to user devices 120 for presentation via application 121 as part of AR experiences. Scene objects may symbolically or otherwise be associated with the provider of content (e.g., a scene object may include a logo of a content provider), and/or may symbolically or otherwise be indicative of the content accessible via interaction with the scene object (e.g., symbols indicating video or audio, snippets/excepts/samples from the content, etc.). Example scene objects 215 (or portions thereof) are illustrated in FIG. 14. Digital content representations of scene objects may include: URL pointing to a file (such as a presentation, spreadsheet, text, PDF, or MS Word document); URL to a video (which may be hosted externally at a site such as YouTube); URL to audio (which may be hosted externally at a site such as SoundCloud); URL to a webpage; URL to a video that is played within the AR scene; URL to audio that is played in the AR scene and/or streamed; picture shown in the AR scene; message shown in the AR scene; phone number linked to a call action; phone number linked to a “send SMS” action; e-mail linked to a “send e-mail” action; social network link, page, or action (such as LinkedIn/Facebook, Twitter); etc.

In some implementations, the scene objects can be configured to provide an interface through which a user of a client device can provide an input relating to the scene object. Values that may be input or output with respect to scene objects include: a panel to select a rating (numerical); a slider (flat or rotating) to input a numerical value; a thumbs up/thumbs down (Boolean data type); an input panel that lets the user type a text string; a number from a URI; a Boolean (on/off, open/close) from a URI; a string from a URI; etc. Other example scene object representations/values include a box/package, which contains another mystery object; a collectable coin/point; a zone (a physical area) circular or rectangular; welcome/info panel (when someone opens a layer); check-in object (which aligns the user's position with physical markers in the user's surroundings); etc.

Each scene object 215 may be associated with triggers 220, presentation attributes 225, access policies 230, and interactor behaviors 235. Triggers may be used to identify what will trigger 220 the presentation of a scene object. Example triggers include locations (e.g., area 200 or a subsection of area 200, such as in a particular room in a building), images and videos in the vicinity of the client device (captured, e.g., via a camera of the client device targeting the surroundings of the user), connection to a certain Bluetooth or Wi-Fi network using a communications interface of the user device; sounds (captured, e.g., via a microphone of the user device); etc. In certain implementations, sounds, images, and/or videos used as triggers may be captured in real time (or near real time if there is a delay) corresponding to the current (or recent, in case of delays) surroundings of the user. Triggers 220 may also require that sounds, images, and/or videos were captured within a certain time (e.g., no more than an hour prior, or on the same day, etc.), or captured within a specified time window (e.g., between specified hours on one or more specified days).

In example implementations, triggers 220 may be used as part of a scavenger/treasure hunt. For example, a user device 120 may present (via application 121) a first scene object at a first location (e.g., a starting point of the hunt). The first scene object may provide a document, a sound recording, a video, text, etc., with a clue or instructions for reaching a second location and/or for finding a physical object. Application 121 can be configured to detect changes in location and surroundings to determine whether the user device 120 is approaching or has reached the second. In some implementations, this can be accomplished using the camera/microphone 122 of user device 120 (e.g., to recognize imagery of objects in the vicinity of the second location, such as paintings in a museum, or to detect sounds expected to be in the surroundings of the second location, such as the sounds of a crowd at a conference center, shoppers at a mall, horns and engines of cars in a street in front of the entrance to a building, etc.). In other implementations, this can alternatively or additionally be accomplished using communications interfaces 113 (e.g., to detect the Wi-Fi signal provided by a business center of a hotel at the second location), location and orientation sensors 114 (e.g., to detect GPS signals identifying latitude and longitude coordinates associated with the second location), and/or user interfaces (e.g., to accept user input of a passcode or other data that is obtained by reaching the second location). In some implementations, application 121 may determine the required location of the client device 120 by accepting a recent photograph (e.g., of a landmark), video (e.g., of billboard with changing content provided on a screen), or audio clip (e.g., of a sound of a train whistle or announcement broadcast via a public announcement (PA) system) acquired using client device 120 at the second location.

If application 121 detects the required change in location or receives an input indicating that a physical object (such as a painting in a museum or an item in a storefront) has been reached within a specified time or during a specified time period, a second scene object may be triggered. The second scene object may be triggered, for example, by an image capture of the found item, connection to a Wi-Fi network, etc. The second scene object (which may be presented by client device 120 via user interface 125 if the user is successful at reaching the destination as instructed via the first scene object) may provide access (via application 121) to, for example, a video of the organizer of the hunt providing information related to the next destination or goal (via, e.g., a riddle or clue leading the user to another geographic location). Different scene objects may be triggered/presented depending on which destinations/goals (which may vary in difficulty, time commitment, travel requirement, etc.) have been reached/accomplished using client device 120.

Presentation attributes 225 may include one or more fields with one or more values identifying or indicating how a scene object is presented via application 121 of client device 120 as part of an AR experience, such as its size, apparent distance from a user, elevation, whether the scene object 215 rotates as the user moves, etc. These attributes may be used, for example, by a content presentation manager 129 of application 121 running on user device 120 to control how the scene object augments the user's reality or is otherwise presented via user interfaces 125.

Access policies 230 may include fields with values identifying or indicating conditions that must be satisfied before a scene object 215 is presented via application 121. For example, only certain individuals (or a single individual) may have permission to be presented with the scene object 215. Access policies 230 may also indicate that a user is only presented for a limited time, or during a defined time period. In certain implementations, the access policies 230 may require that a user provide certain information via application 121 (such as a passcode) to be presented with scene objects 215 (or a subset of scene objects 215) and/or digital assets.

Interactors 235 may include fields and values that can be used by client device 120 to implement behaviors for scene objects. Interactors 235 may be associated to a scene object, and act as the interface between the scene object and events that are created by via the user device 120 (e.g., a touch event via user interface 125), the object manager (e.g., a creation event arising from a creation or modification of an AR experience via editor device 110) or the device itself (e.g., proximity of user device 120 to a location). In various implementations, interactors 235 may call one or several “actions” as a result of certain event patterns being detected. Actions include: open an asset, which opens the underlying digital asset; view details, which opens a panel displaying details about the scene object, as well as predefined actions for the asset; collect an asset, which saves the asset in the users storage; call a number (for a phone number asset); create a new email (for an email asset); etc. Some actions may also tie back to some data on the server side: message (string); rating panels (integer); thumbs up/down (Boolean); pledge/donate button (email, float); etc.

In certain implementations, interactors may identify how a user may interact with the scene object 215. For example, a first interactor may indicate that a user can only view certain objects, and another interactor may indicate that a user may “collect” (e.g., save in their personal backpack) the scene object/digital asset for later viewing.

Behaviors may define how a scene object behaves when interacted with (e.g., touch/click, drag and drop, proximity, focus/blur, etc.). A set of pre-defined behaviors may be provided, referenceable by name. Behaviors may be used to account for platform-specific constraints (e.g., a button interactor can use the gaze of a user, as opposed to a click, if deployed using smart glasses). Behaviors may be used to drive the consistent execution of actions, such as: how to open a digital asset associated with a scene object; how to view the description of an asset before opening it; how to collect a digital asset; when to show/hide a scene object representation based on range (i.e., how far the scene object is relative to the user); etc.

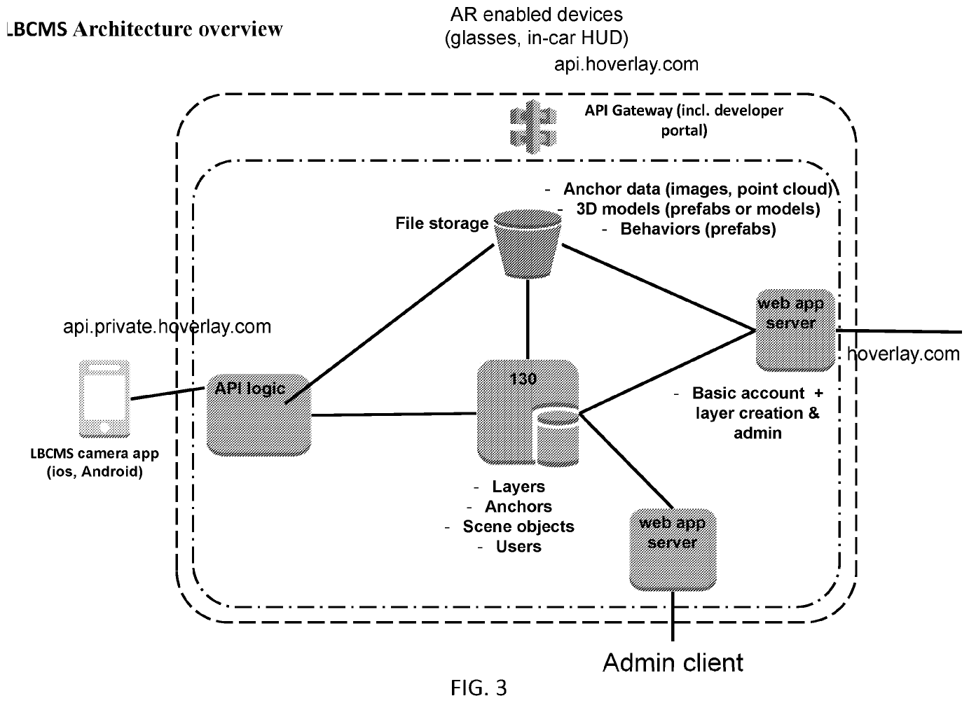

Referring to FIG. 3, an example cloud server system (implementing the content management system 130) may support different types of clients, four of which are presented here in no particular order. First, depicted arbitrarily on the left, a mobile client with a camera-based application (iOS, Android, etc.) may be used by end customers to discover AR content (as “consumers” of content), or tag places and things with scene objects (as “editors” who design AR experiences to publish their content). Second, on the right, a public web client may be used by end customers to sign-up/sign-in, create a layer, and manage their scene objects and digital assets. Third, on the bottom, a private administrative client may be used by administrators of the content management system 130 to view, edit, and/or delete any entity or element created in the system (e.g., layers, anchors, scene objects, users, etc.). And fourth, at the top, a portal may allow end user development teams to connect new clients or device types, or load scene objects and anchors. This portal (depicted at the top) may provide documentation and self-service key generation in connection with such AR-enabled devices as smart glasses and in-vehicle heads-up displays (HUDs). The clients may interact with the server via public or private application programming interfaces (APIs).

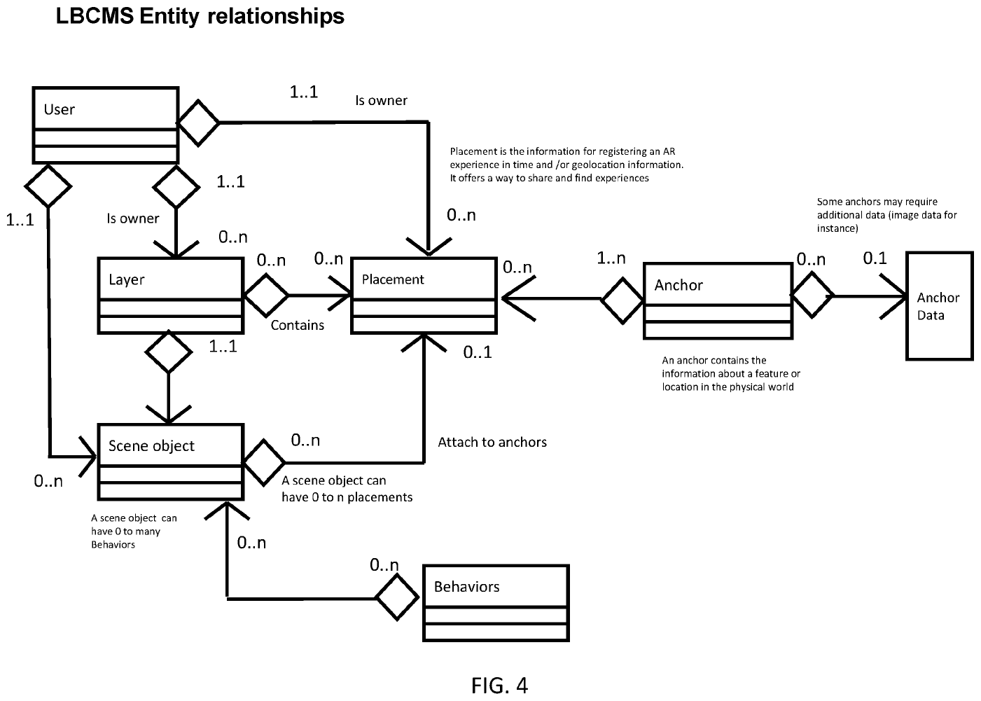

FIG. 4 depicts an example set of entity relationships. A user (such as an editor of an AR experience, or a consumer of an AR experience) may be associated with one or more layers, scene objects (which can have zero to many predefined behaviors), and placements (i.e., information for registering an AR experience in time and/or geolocation, providing a way to share and find experiences). A layer can be associated with users, scene objects, and placements. And placements can be associated with users, layers, scene objects, and anchors. Some anchors may require additional data (e.g., image data).

In various implementations, the entity “layer” is the entry point into an augmented reality space. Each layer has an owner, and each user can create one or more layers. Layers contain virtual objects (referred to as “scene objects”) that augment the physical world. Layers may be uniquely defined by a human readable layer identifier. A layer identifier may be a string that always starts with a specific character (such as start “*” or other character), which may be followed by, for example, a series of alphabetical, numerical, and special characters, separated by a period (“.”) or other character. For instance: *berklee.edu; *room25.berklee.edu; *ny.city.com; and *nike.com. Layers can also be associated with a visual marker, which the app may use to tune to that layer. Layers can be read only (i.e., only layer owners can write to that layer), read/write, or write only. Users may be allowed to add and edit scene objects they own in write-enabled layers.

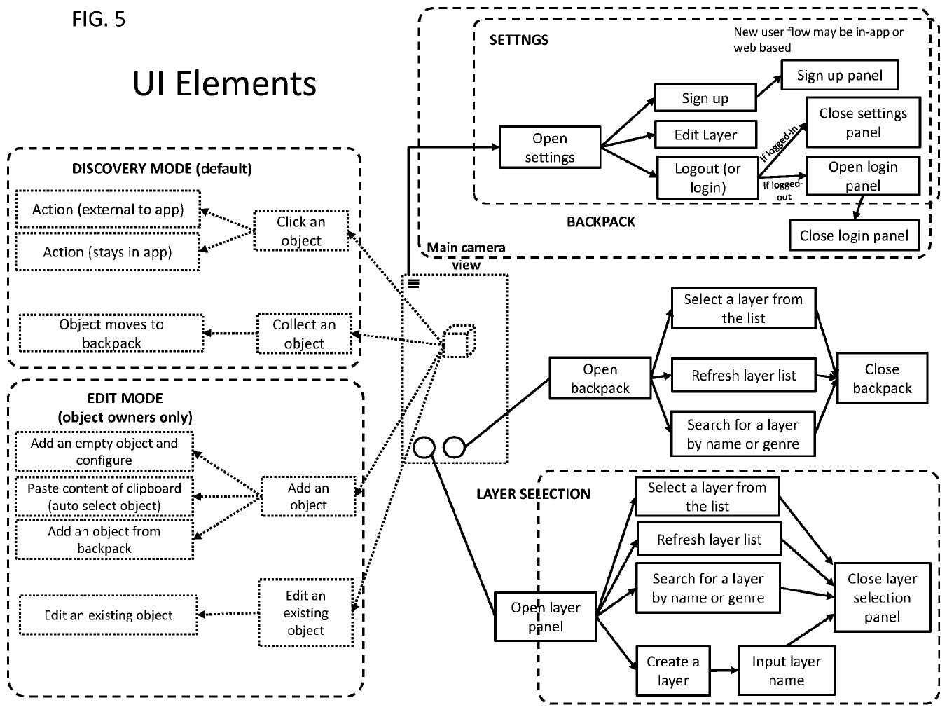

FIG. 5 depicts an example set of user interface interfaces (UIs) and UI elements. An application (“app”) running on a client device may be a camera app (i.e., an app that receives imagery from a camera and modifies or augments the imagery). A user running a camera app may be in Discovery Mode by default. In this mode, a user can click a scene object to access corresponding content. This access may be external to the application (such as a link that redirects the user to another application, such as a web browser, social networking app, video player, etc.), or it may be internal, with the user staying in the app environment (such as a digital asset being overlaid on the imagery from the camera or otherwise being played/presented from within the app). Depending on access permissions, a user may be able to also collect scene objects for later access of the associated content, and/or collect digital assets associated with scene objects, by placing the scene object and/or digital asset in the user's backpack.

Owners of scene objects may enter an Edit Mode, which allows users (editors) to add scene objects and edit existing objects. To add an object, a user may add an empty object (e.g., a shell or template based on a model), configure the appearance of the object, and identify the content (i.e., digital assets) with which the scene object is associated. A user may “paste” content, such as by selecting text and files, into the app. The app, in response, may auto-select or generate a scene object based on the content. For example, a link to a LinkedIn page may auto-select the LinkedIn logo and insert the picture associated with the LinkedIn page (see, e.g., FIGS. 14 and 18). Similarly, pasting an audio clip may auto-select the speaker icon (shown in FIG. 14 with wave lines representing sounds emitted from the speaker) as the scene object (or a portion thereof). The user may also add an object from a backpack, such as previously-collected content or files saved to the user's backpack. Editing an object may allow the user to change the digital asset associated therewith, the behavior of the scene object, etc.

A user may also change settings by entering a “Settings” mode/opening a “Settings” UI, to sign up for AR experiences, exit layers, and log in/log out. The user may also, if logged in, close the settings panel or, if logged out, open the login panel (which may subsequently be closed).

The application 111, 121 of client devices 110, 120 may, in some implementations, provide two selectable icons on the screen o fuser interfaces 125 (see, e.g., FIG. 18). For example, a first icon (arbitrarily placed at the bottom left in FIG. 5) may open the layer panel, which may allow a client device 110, 120 to select a layer from a list, refresh the list of available layers (which may change as the user changes physical location or new layers are added), and search for a layer by, for example, name or genre. The client device 110, 120 may also be used to create a layer and input a layer name via application 111, 121. When done, the layer selection panel may be closed by application 111, 121. A second icon (arbitrarily placed at the bottom right in FIG. 5 by application 111, 121) may allow a user to open his or her backpack. Once a backpack is selected, a user may use the application 111, 121 to select a layer from a list, refresh the layer list, and search for a layer by name or genre. When done, the backpack may be closed via application 111, 121.

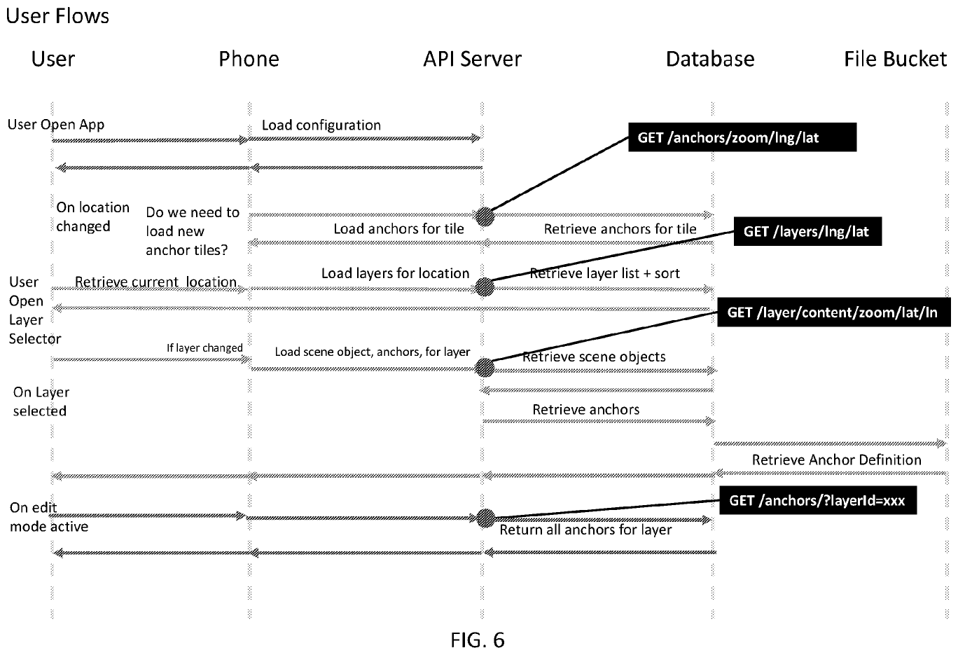

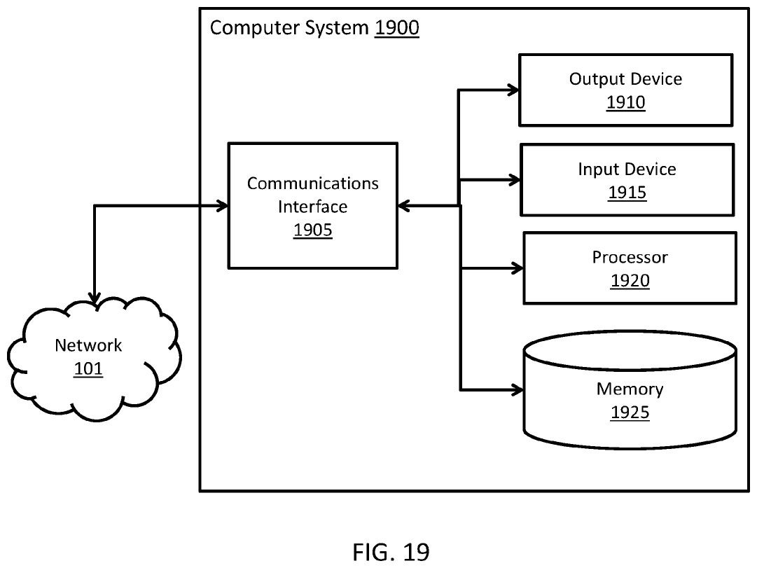

Now referring to FIG. 6, depicted are example user flows. The functionality described herein can be performed or otherwise executed by the system 100 as shown on FIG. 1 (e.g., the content management system 130, the content publisher 110, and the client device 120) and/or a computing device as shown in FIG. 19 or any combination thereof.

A user may launch an application running on his or her device (e.g., his or her smartphone), and the device may load configuration data via an API server (e.g., content management system 130). If it is determined that the device (and thus the user) has changed location since the prior use of the app, the device may retrieve and load from a relevant database, via the server, the anchors for the relevant geographic region (e.g., the tile in which the device is now located). The device may also retrieve, load, and sort the layers that are associated with the current location of the user device. If a layer has changed since the last time it was accessed by the device, the current scene objects associated with the layer may be retrieved, along with the anchors associated with the scene objects and corresponding anchor definitions. The user may enter Edit Mode, if the user has access permissions for the Mode, to make changes to one or more scene objects and/or digital assets associated with the scene objects.

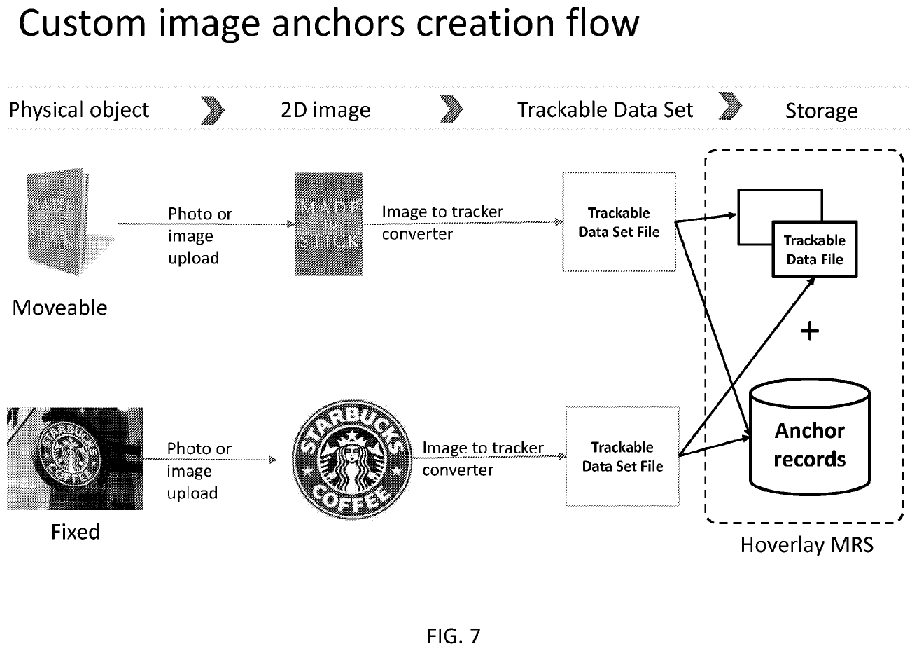

Referring to FIG. 7, a physical object (such as a book cover or sign in an uploaded photo or image) may be converted to a 2D image. This may then be converted to a trackable data set and stored in the trackable data files and anchor records. Scene objects may be represented in the client app using 3D or 2D objects. The format of the 3D object can be dependent on the 3D rendering framework used in the app. The representation of a specific scene object may be defined by a field indicating a type defined using a Uniform Resource Name (URN) type syntax: name_space::collection_name::model_name::version (such as hoverlay::essentials::linkedInProfile::010). Each scene object may have a graphical representation in the app. The management system may provide a set of predefined objects in the app, but new objects could be loaded dynamically. 3D and 2D objects may be identified uniquely using a format such as {type}: {namespace}: {collection}: {object}: {version} (e.g., unity3d:hoverlay:essentials:LinkedInProfile:010, unity3d:hoverlay:conferencePack:agenda:021, and fbx:turbosquid:WindTress:243576010).

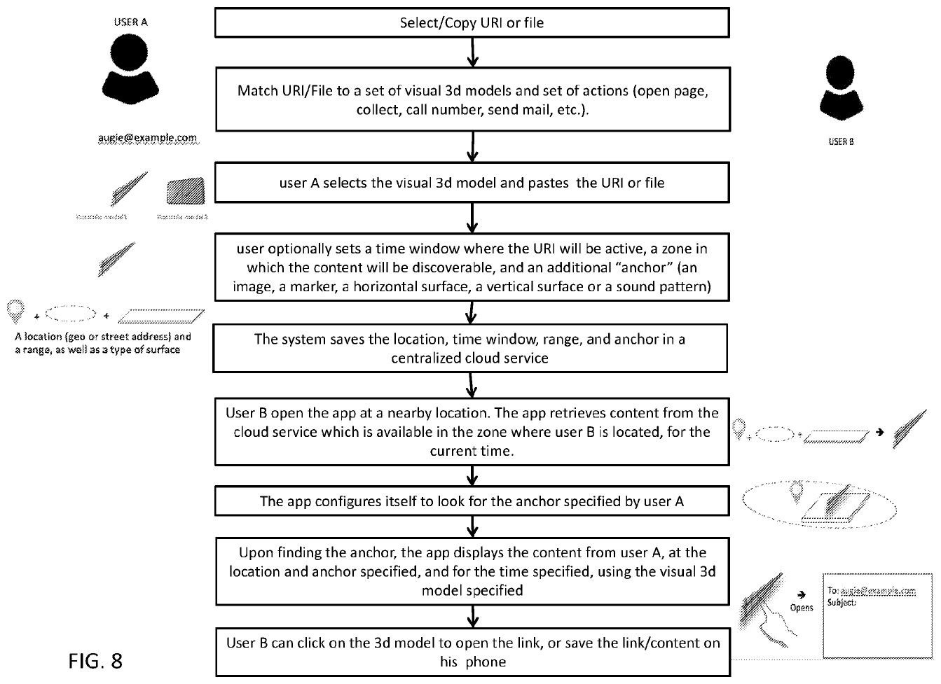

Referring to the example process in FIG. 8, to create one potential AR experience, user A selects and copies a URI, email address, or phone number on his or her phone, and opens the user app running on the phone. The app automatically may match URI/File to a set of possible visual 3D models and set of possible actions for that URI (such as open page, collect, call number, send email, etc.). User A may select the final visual 3D model to use. For placement/registration in the physical world, the user optionally sets a time window in which the object will be active, a geographic zone in which the content will be discoverable, and an additional “anchor” (such as an image, a marker, a horizontal surface, a vertical surface, or a sound pattern). The system saves the location, time window, range, and anchor in a centralized cloud service. For retrieval, user B opens the app at a nearby location. The app retrieves content from the cloud service which is available in the geographic zone in which user B is located, for the current time. The app configures itself to look for the anchor specified by user A. Upon finding the anchor, the app displays the content from user A, at the location and anchor specified, and for the time specified, using the visual 3D model specified. User B can click on the 3D model to open the link, or save the link/content on his or her phone or in the cloud.

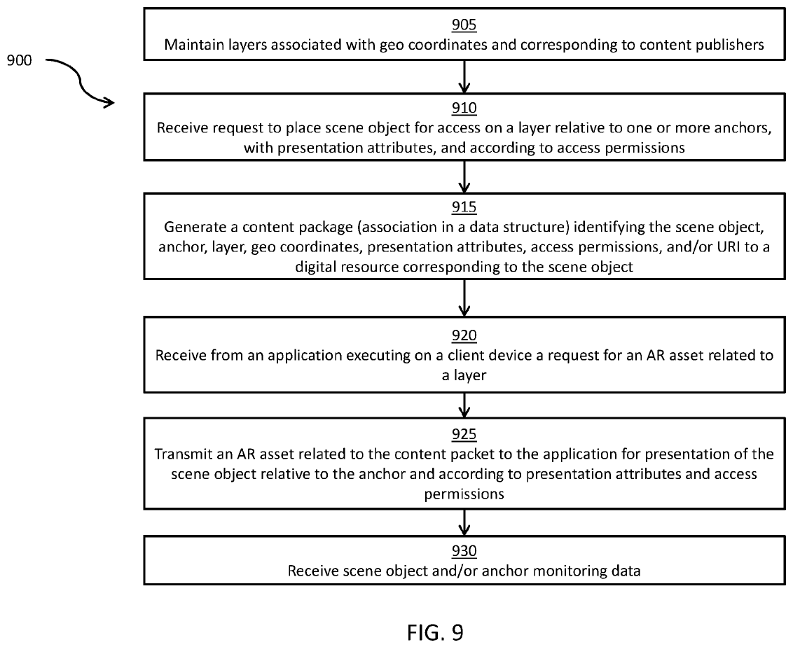

Referring to FIG. 9, at 905, a server (e.g., one with a content management system) may maintain layers associated with geographical coordinates and corresponding to content publishers. At 910, the server may receive a request (from, e.g., a client device) to place a scene object for access on a layer. At 915, the server may generate a content package identifying the scene object, anchor, layer, geographical coordinates, presentation attributes, access permissions, and URI to a digital asset corresponding to the scene object. At 920, the server may receive, from an application executing on a (second) client device, a request for an AR asset associated with the layer. At 925, the server may transmit the AR asset to the application for presentation of the scene object relative to the anchor and according to the presentation attributes and access permissions. At 930, the server may receive scene object and anchor monitoring data.

In further detail, at 905, a server (e.g., one with a content management system) may maintain layers associated with geographical coordinates and corresponding to scene objects and digital assets. The server can be configured to maintain a table associating geographical coordinates to layers (see, e.g., FIG. 2B). Each layer can be associated with a content publisher. Responsive to a request from a client device 110 to establish a layer, the server may receive from application 111 selections and customizations of geographic locations, scene objects, digital assets, etc.

At 910, the server may receive a request (from, e.g., a client device 110) to place a scene object for access on a layer. In some embodiments, the server may receive a request to place a plurality of scene objects on a layer. The request may identify an anchor relative to which the scene object is to be presented. Presentation attributes and access permissions may also be included in the request. In some implementations, application 111 may identify an anchor (identified using anchor locator 116) by providing content management system 130 with one or more images/videos of the physical object to be used as anchor (e.g., images showing the object from multiple angles). The content management system 130 may then provide all or a subset of the received images to user device 120. Anchor locator 126 of application 121 may, in some implementations, use the images to identify anchors in the surroundings of user device 120.

At 915, the server may generate a content package. The content package may include data (such as imagery of an anchor) to be used to locate an anchor with which the scene object is associated. The content package may also include data identifying the layer, geographical coordinates, presentation attributes, access permissions, as well as a URI to a digital asset corresponding to the scene object. In some embodiments, the server may establish associations between the scene object, the layer, the geolocation, the anchor, the presentation attributes and the access policies provided by the content publisher. The server may maintain a data structure that establishes these associations.

At 920, the server may receive, from an application 121 executing on a (second) client device 120, such as a consumer, a request for an AR asset corresponding to the layer. The request may identify the location of the user device 120. The request may be generated at the application 121 responsive to the server providing a plurality of layers available to the client device to access. Responsive to a selection of one of the layers, the application 121 can generate the request an AR asset corresponding to the selected layer.

In some embodiments, responsive to the application 121 requesting access to content of a particular layer, the server 130 can be configured to generate a layer AR asset that includes one or more digital assets 170 corresponding to the particular layer identified in the request. The server 130 can generate the layer AR asset by aggregating all digital assets (or a subset thereof) associated with the layer or with anchors associated with the layer. The server can then send the layer AR asset to the application 121. The application 121 can then load the layer AR asset to identify one or more digital assets available for access by the user.

At 925, the server may transmit the AR asset to the application 121, which may present the scene object relative to its anchor and according to the presentation attributes and access permissions, when the user device 120 detects the applicable location of the user device 120 and any applicable triggers required for presentation of the scene object. The AR asset may be a stream of data that the application 121 can use to present scene objects associated with the layer relative to anchors.

At 930, the server may receive scene object and anchor monitoring data. The server may receive data from the client device indicating information about each time a scene object is presented to the client device. In some embodiments, the server may receive data from the client device indicating information about each time an anchor is detected or tracked by the client device. The server may store the information about the scene object and the anchor and use this data to determine an aggregate frequency of presentation of various scene objects as well as the trackability of anchors.

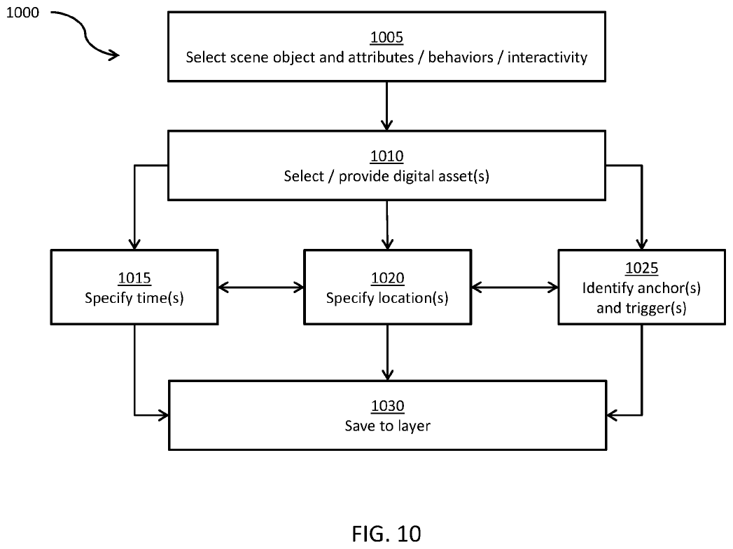

Referring to FIG. 10, depicted is a flow diagram for example method 1000 of designing an AR experience for one or more users. The functionality described herein with respect to method 1000 can be performed or otherwise executed by the system 100 as shown on FIG. 1 or a computing device as shown in FIG. 19, or any combination thereof. At 1005, a first user (editor, designer, or creator of an AR experience) may select a scene object and attributes, behaviors, and interactivity thereof. At 1010, the first user may select (e.g., identify a link to) or provide (e.g., by copying and pasting, uploading, etc.) a digital asset to be accessible via the scene object. The first user may select one or more of: certain times during which the scene object is presented and/or during which the digital asset is accessible via the scene object, at 1015; locations (e.g., latitude/longitude coordinates, geographic region, address, intersection, landmark, etc.) at which the scene object is presented and/or during which the digital asset is accessible via the scene object, at 1020; and/or the anchors and triggers associated with the scene object, at 1025. The first user may then save the scene object (and associated attributes, behaviors, interactivity), digital assets, and times/locations/anchors and triggers) to a layer that may be searchable, discoverable, or otherwise accessible to one or more other users.

Although in FIG. 10, step 1005 is identified as preceding step 1010, in other implementations, the steps can occur in reverse order. For example, in some implementations, an editor may use an application to select and/or provide digital assets. The system may then identify the digital assets and determine which scene object(s) may appropriately correspond with the digital assets. In some implementations, the determination may be based, in whole or in part, on what other scene objects have selected by other editors (or previously by the same editor) for the type of digital asset being selected/provided. The determination may also be based on predetermined rules that associate certain scene objects with certain (types of) digital assets. As suggested above, for example, a digital asset that is a link to a LinkedIn page may result in a recommendation that the LinkedIn logo be used as the scene object (or a portion thereof). In certain implementations, the system may determine or retrieve scene objects from third-party sources (e.g., via the Internet) by, for example, accessing a webpage that is hyperlinked by the digital asset retrieving an image, logo, icon, etc., associated with the webpage. One or more scene objects identified by the system may, in some implementations, be presented as a recommendation or selectable option, and an application on an editor's client device may be used to accept, reject, or modify the proposed or recommended scene object(s).

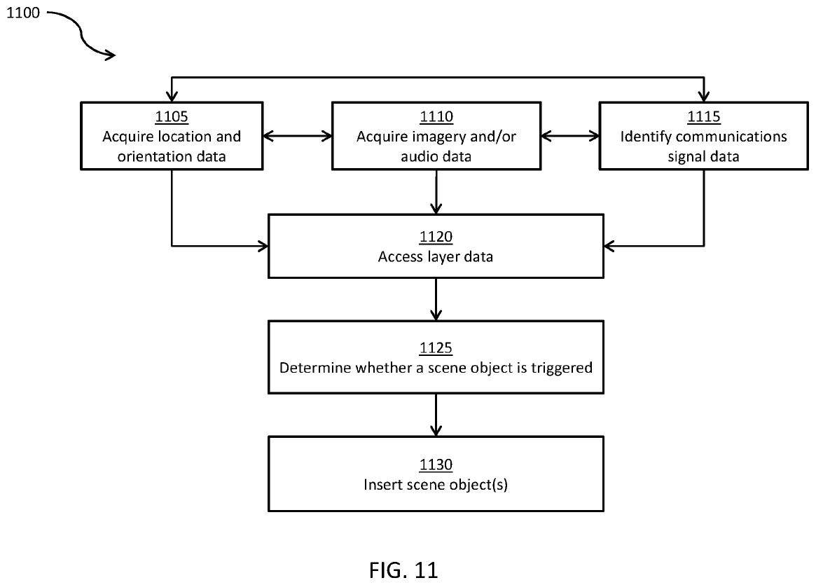

Referring to FIG. 11, depicted is a flow diagram for example method 1100 for experiencing (“consuming”) an AR experience. The functionality described herein with respect to method 1100 can be performed or otherwise executed by the system 100 as shown on FIG. 1 or a computing device as shown in FIG. 19, or any combination thereof. At 1105, a device of a second user (consumer of an AR experience) may acquire (via, e.g., an app running thereon) location and orientation data (using one or more sensors such as a GPS, gyroscope, compass, etc.). At 1110, the device may also acquire imagery and/or audio data (using, e.g., a camera and/or a microphone). At 1115, the device may also, using one or more communications interfaces, identify specific communications signals for certain computing devices that are within range (via, e.g., Bluetooth signals, Wi-Fi networks, NFC with particular devices, etc.). At 1120, the device of the second user may then determine which layers are accessible to the second user in the geographic area in which the device is located. At 1125, the device may then determine whether a scene object is triggered. This may be based on whether the anchors associated with the scene objects are within view of a camera app running on the device, and/or whether the required locations, images, sounds, signals, etc., have been encountered. At 1130, if the scene object is triggered, a scene object is inserted into a scene relative to its associated anchor.

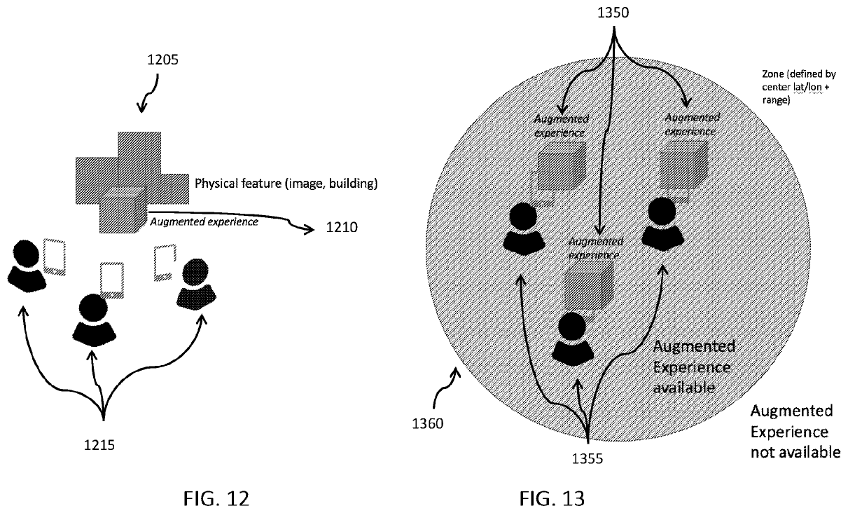

Referring to FIG. 12, users 1215, using their separate devices, view virtual object 1210 relative to physical feature 1205 from a different perspective depending on their positions relative to the object 1210. This approach provides a different AR experience for different users based on differences in location. If the differences in position are relatively insignificant for what is being shown (e.g., if showing the side of an object is not useful, or if what is being shown is effectively two-dimensional), this approach uses more processing power than necessary (and consequently, slow down the device and/or reduce the battery life for the device), as each user device must determine (e.g., by analyzing the imagery captured using the corresponding camera of the device) whether the user moves and how the image should be presented differently from frame to frame. The smoother the changes in perspective are to be, the greater the “frame rate” of the object 1210 being presented, and the more processing power required to calculate changes and present the object 1210 from varied perspectives. The approach represented in FIG. 13 can provide a more consistent and uniform experience for users 1455, not necessarily according to their position relative to virtual objects 1450, but rather based on whether the users are within geographic zone 1450 (outside of which the augmented experience is not available), and on whether the anchor/trigger are detected. The center of zone 1450 may be defined by, for example, latitude/longitude coordinates for its center and a range (i.e., a radius or maximum distance from the center).

A mobile app may enable the consumer of the AR experience to sign-up for the AR service, find/see what layers are active in her location, and select the layer that corresponds to her interest. The consumer may then view scene objects around her from that layer. In various embodiments, users can discover objects using a visual view via map scenes and live camera scenes. The user can discover objects in his or her vicinity by, for example, visualizing his or her location on a 3D map through an avatar, and clicking on objects that appear on the map. In other implementations, the user can discover objects around him or her by scanning an image using a camera-like experience, viewing objects overlaid in AR, and clicking or otherwise selecting those objects. The user can click on/select objects, see their description, and/or collect/execute/open the underlying asset. The user can also see what objects she has already collected in his or her backpack. The user's backpack may be a container for all objects that have been collected by the user, including URLs, 3D objects, or assets (pictures, sounds files, etc.). Collected items may be indexed by date and location, making it easier for the user to search for assets based on their recollection of time and space.

In various implementations, one or more of the following file types may be used. An “anchor source file” (unprocessed) may be an input file used for generating an anchor data file that may be used by the client app. A typical anchor source file may be a png or jpeg file, and may be provided by users (e.g., content publishers). An “anchor data file” (processed) may contain the data required to initialize a camera for a given anchor (for instance, detecting a specific image in the live camera feed). An anchor data file may be generated from an anchor source file by an encoding process, running in real time or in batch.

An “asset bundle” may contain unity3D assets such as new models, materials, and textures, and can be loaded by the mobile app at run-time. It may typically contain a new 3D object which was not in the set of prebuilt objects when the app was invoked. An “asset bundle” may be created in the Unity editor during edit-time, and the files may be created by administrators of a content management system (or partners thereof) and deployed by personnel of the entity maintaining the content management system. “Resource” files may be used to support the personalization of scene objects. For instance, a logo file used to texture a cube. Resource files may include a user photograph or a logo to use on scene objects.

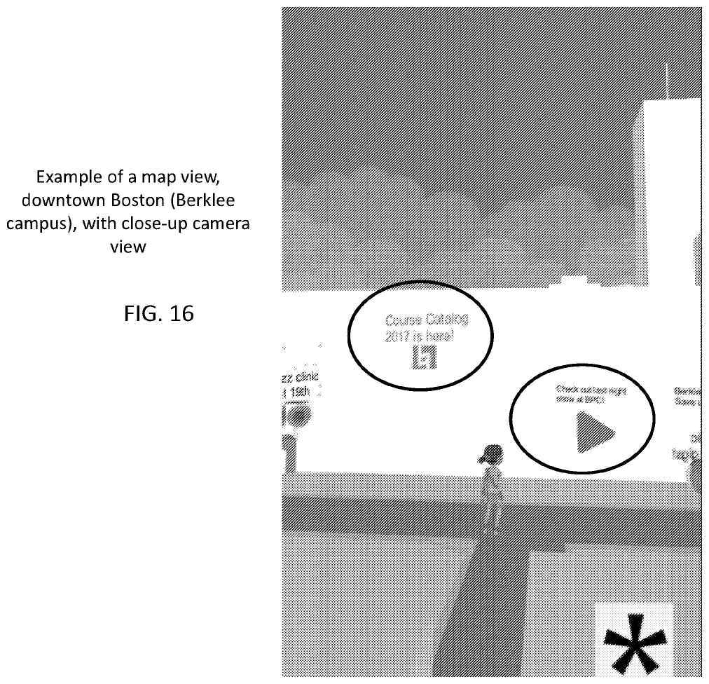

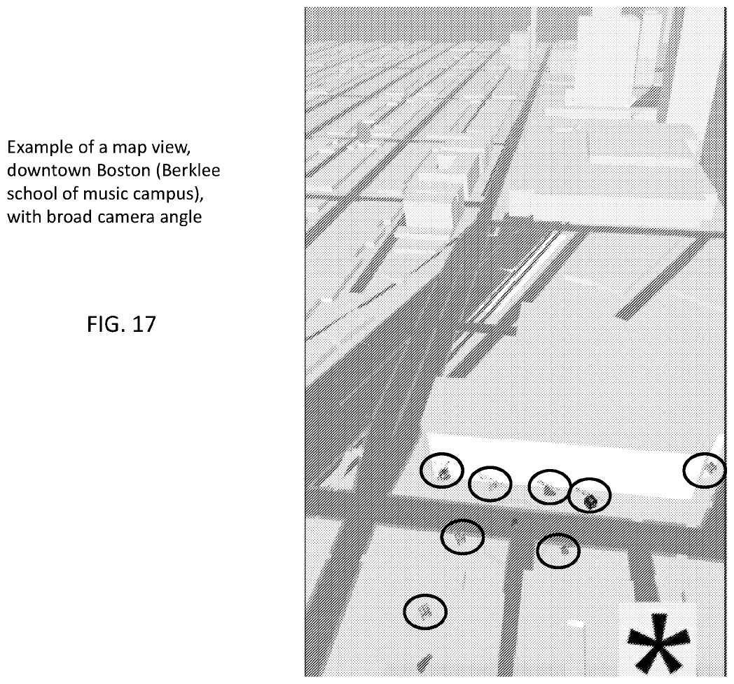

Referring to FIG. 16, provided is an example of a map view of downtown Boston (specifically, the campus of Berklee College of Music), with a close-up camera view. The AR experience provides a scene object stating that “Course Catalog 2017 is here!” (circled on left) along with a symbol. The resource associated with this scene object may be a webpage or PDF (or link thereto) with the 2017 course catalog, and may become accessible to the user who selects that scene object. A second scene (circled on right, stating “Check out last night's show at BPC!”) is associated with audiovisual media. FIG. 17 provides an example map view of downtown Boston (also the campus of Berklee College of Music), with broad camera angle. A set of scene objects (circled) are viewable in FIG. 17. A user may zoom into the map and/or select one of the scene objects to access corresponding digital assets. The scene objects in FIGS. 17 and 18 may be associated with one layer (such as +BerkleeCollegeofMusic) or multiple layers. FIG. 19 provides an example of a live camera view, augmenting a marker with social media links. Here, the scene object includes an image of a person and icons for networking platforms at which the identified person has accounts/profiles/handles. In some implementations, the anchor used may be a table or wall. Optionally, a scene object may have a “floating” or “hovering” anchor, such that the scene object is not presented with respect to a physical object in the user's surroundings but rather, for example, relative to the user. As an example, a scene object with a floating anchor may be presented such that it appears to be a given distance away from the user device (e.g., 2 meters) and/or with a specified orientation. The user's surroundings may be shown moving in the background (i.e., behind the scene object) as the device running the camera app is moved by the user.

FIG. 19 shows the general architecture of an illustrative computer system 1900, one or more of which could be employed to implement each of the computer systems discussed herein (including the content management system 130 and its components, the content publisher 110 and its components, and the client device 120 and its components) in accordance with some implementations. The computer system 1900 can be used to provide information via the network 101 for display. The computer system 1900 of FIG. 19 comprises one or more processors 1920 communicatively coupled to memory 1935, one or more communications interfaces 1905, and one or more output devices 1910 (e.g., one or more display units) and one or more input devices 1915.

In the computer system 1900 of FIG. 19, the memory 1925 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the content management system 130 can include the memory 1925 to store information related to the availability of one or more scene objects and/or digital assets, among others. The memory 1925 can include the database 180. The processor(s) 1920 shown in FIG. 19 may be used to execute instructions stored in the memory 1925 and, in so doing, also may read from or write to the memory various information processed and or generated pursuant to execution of the instructions.

The processor 1920 of the computer system 1900 shown in FIG. 19 also may be communicatively coupled to or made to control the communications interface(s) 1905 to transmit or receive various information pursuant to execution of instructions. For example, the communications interface(s) 1905 may be coupled to a wired or wireless network, bus, or other communication means and may therefore allow the computer system 1900 to transmit information to or receive information from other devices (e.g., other computer systems). While not shown explicitly in the system of FIG. 1 or 19, one or more communications interfaces facilitate information flow between the components of the system 1900. In some implementations, the communications interface(s) may be configured (e.g., via various hardware components or software components) to provide a website as an access portal to at least some aspects of the computer system 1900. Examples of communications interfaces 1905 include user interfaces (e.g., webpages), through which the user can communicate with the content management system 130.

The output devices 1910 of the computer system 1900 shown in FIG. 19 may be provided, for example, to allow various information to be viewed or otherwise perceived in connection with execution of the instructions. The input device(s) 1915 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

It should be appreciated that, although the AR assets have been discussed in the context of AR or mixed reality systems, in other implementations, the AR assets could be presented in VR environments as well.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable a receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, or other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In some implementations, the features may be implemented on a laptop computer or other personal computer, a smartphone, other mobile phone, handheld computer, a tablet PC, or other computing device. In some implementations, the features disclosed herein may be implemented on a wearable device or component (e.g., smart watch) which may include a processing module configured to integrate internet connectivity (e.g., with another computing device or the network 101).

The operations described in this specification can be implemented as operations performed by a data processing apparatus on data stored on one or more computer-readable storage devices or on data received from other sources.

The terms “data processing apparatus”, “data processing system”, “user device” or “computing device” encompasses all kinds of apparatuses, devices, and machines for processing data, including by way of example a programmable processor, a computer, a system on a chip or multiple chips, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content item evaluator 130 and the script inserter 145 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from read-only memory or random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well. For example, feedback provided to the user can include any form of sensory feedback, e.g., visual feedback, auditory feedback, or tactile feedback, and input from the user can be received in any form, including acoustic, speech, or tactile input. In addition, a computer can interact with a user by sending documents to and receiving documents from a device that is used by the user, for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 1900 or system 100 can include clients and servers. For example, the content management system 130 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. The components of content management system 130 may be a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to augmented reality experiences, the systems and methods described herein can include applied to other environments. The foregoing implementations are illustrative rather than limiting of the described systems and methods. The scope of the systems and methods described herein is thus indicated by the appended claims, rather than the foregoing description, and changes that come within the meaning and range of equivalency of the claims are embraced therein.

What is claimed is:

1. A method for providing digital content in an augmented reality environment, the method comprising:
maintaining, by a server, one or more layers associated with a particular set of geographical coordinates, each layer corresponding to a respective content publisher;
receiving, from a first device of the content publisher, a request to provide a scene object for access on a layer, the request identifying an anchor relative to which to present the scene object, one or more presentation attributes and one or more access permissions;
generating, by the server, a content package identifying the scene object, the anchor, the layer, the set of geographical coordinates, the one or more presentation attributes, the one or more access permissions and at least one of a resource corresponding to the scene object and a link to a location at which the resource is stored;
receiving, by the server from an application executing on a second device of a client, a request for an AR asset related to the layer; and
transmitting, by the server, the AR asset to the application, the application configured to present the scene object included in the AR asset on a display at a physical location associated with the anchor according to the one or more presentation attributes and access permissions.

2. The method of claim 1, wherein the application is further configured to, upon selection of the scene object, provide access to a resource.

3. The method of claim 1, wherein the resource is at least one of an image, a sound, a video, and a document.

4. The method of claim 1, wherein the application is further configured to display real-time imagery from a camera of the client device, and wherein the anchor is a physical object in the imagery.

5. The method of claim 4, wherein the physical object is at least one of a substantially vertical wall and a substantially horizontal flat surface.

6. The method of claim 1, wherein the application is further configured to display a map of a geographical location of the client device, and wherein the anchor is an object viewable in the map.

7. The method of claim 6, wherein the object is a representation of a building at the geographical location.

8. The method of claim 1, wherein the anchor identifies a wall on which the scene object is to be displayed.

9. The method of claim 1, wherein the application is further configured to vary a size of the scene object such that the size decreases as the client device approaches the scene object and the size increases as the client device moves away from the scene object.

10. A method for creating, via a client device of a client, an augmented reality experience for a user device of a user, the method comprising:
transmitting to a server, via an application running on the client device, a resource to be made accessible to the user device via the server;
selecting, via the application, a scene object to be associated with the resource, a set of presentation attributes for the scene object, and one or more access permissions for the scene object;
identifying, via the application, a set of preconditions under which the scene object is to be presented to users via the server, wherein the preconditions include at least one of a geographical location and a time period;
identifying, via the application, an anchor relative to which the scene object is to be presented according to the presentation attributes and access permissions on a user display of the user device; and
transmitting, to the server, the identified set of preconditions, scene object selection, presentation attributes, and one or more access permissions for association with a layer corresponding to the client, wherein layers within a predetermined distance of the user device and/or associated with the client are searchable by the user via the server.

11. A system for providing digital content in an augmented reality environment, the system comprising:
a network interface configured to communicate via a telecommunications network; and
a processor and a memory having stored thereon instructions that, when executed by the processor, cause the processor to:
maintain one or more layers associated with a particular set of geographical coordinates, each layer corresponding to a respective content publisher;
receive, from a first device of the content publisher, a request to provide a scene object for access on a layer, the request identifying an anchor relative to which to present the scene object, one or more presentation attributes and one or more access permissions;
generate a content package identifying the scene object, the anchor, the layer, the set of geographical coordinates, the one or more presentation attributes, the one or more access permissions and at least one of a resource corresponding to the scene object and a link to a location at which the resource is stored;
receive, from an application executing on a second device of a client, a request for an AR asset related to the layer; and
transmit the AR asset to the application, the application configured to present the scene object included in the AR asset on a display at a physical location associated with the anchor according to the one or more presentation attributes and access permissions.

12. The system of claim 11, wherein the application is further configured to, upon selection of the scene object, provide access to a resource.

13. The system of claim 11, wherein the resource is at least one of an image, a sound, a video, and a document.

14. The system of claim 11, wherein the application is further configured to display real-time imagery from a camera of the client device, and wherein the anchor is a physical object in the imagery.

15. The system of claim 14, wherein the physical object is at least one of a substantially vertical wall and a substantially horizontal flat surface.

16. The system of claim 11, wherein the application is further configured to display a map of a geographical location of the client device, and wherein the anchor is an object viewable in the map.

17. The system of claim 16, wherein the object is a representation of a building at the geographical location.

18. The system of claim 11, wherein the anchor identifies a wall on which the scene object is to be displayed.

19. The system of claim 11, wherein the application is further configured to vary a size of the scene object such that the size decreases as the client device approaches the scene object and the size increases as the client device moves away from the scene object.
